(19) United States
(12) Patent Application Publication
(10) Pub. No.: US 2013/0288049 A1
(43) Pub. Date: Oct. 31, 2013

(54) COMPOSITE PRODUCTS AND RELATED METHODS

(71) Applicants: Vivek M. Sample, Murrysville, PA (US); J. Daniel Bryant, Murrysville, PA (US); Hasso Weiland, Lower Burrell, PA (US); Eider A. Simielli, Monroeville, PA (US)

(72) Inventors: Vivek M. Sample, Murrysville, PA (US); J. Daniel Bryant, Murrysville, PA (US); Hasso Weiland, Lower Burrell, PA (US); Eider A. Simielli, Monroeville, PA (US)

(73) Assignee: ALCOA INC., Pittsburgh, PA (US)

(21) Appl. No.: 13/848,859

(22) Filed: Mar. 22, 2013

Related U.S. Application Data
(60) Provisional application No. 61/614,905, filed on Mar. 23, 2012.
(60) Provisional application No. 61/658,639, filed on Jun. 12, 2012.
(60) Provisional application No. 61/798,596, filed on Mar. 15, 2013.

(51) Int. Cl. B32B 5/16

(52) U.S. Cl. CPC B32B 5/16
USPC 428/338; 428/539.5; 264/109; 427/327

(57) ABSTRACT

Composite products and methods of making the same are provided.

### CROSS-REFERENCE TO RELATED APPLICATIONS

This application is claims priority to U.S. Provisional Application Ser. No. 61/614,905, entitled “Composite Products and Related Methods” filed on Mar. 23, 2012; U.S. Provisional Application Ser. No. 61/658,639 filed on Jun. 12, 2012 entitled “Composite Products and Related Methods; and U.S. Provisional Application Ser. No. 61/798,596 filed on Mar. 15, 2013 entitled “Composite Products and Related Methods, all of which are incorporated by reference in their entirety herein.

### FIELD OF THE INVENTION

Broadly, the instant disclosure relates to composite products and related methods, where the composite product includes a parent material and a non-parent material, where the non-parent material is embedded, dispersed, and or reduced in average particle size in the parent material matrix of the composite product. More specifically, the instant disclosure relates to composite products and methods of forming composite products by repetitively extruding a parent material having a non-parent material therein/therewith (e.g. coated on, electroplated with, chemically added, co-added, and combinations thereof), thus forming a composite product having a parent material and a non-parent material which is: embedded in, dispersed throughout, and/or reduced in average particle size in the parent material.

### BACKGROUND

Severe plastic deformation (SPD) imparts strength in metal materials by performing redundant plastic deformation, resulting in microstructural refinement and unique metallic structures. Limitations of SPD include: mechanical property improvements by SPD are limited due to dynamic recovery of the microstructure and thermal exposure of SPD enhanced products may result in rapid loss of the enhanced properties.

### SUMMARY OF THE DISCLOSURE

Broadly, the present disclosure relates to composite products formed through a reiterative continuous deformation process, wherein the composite product includes a parent material (e.g. a metal, including but not limited to: aluminum, aluminum alloy(s), magnesium, magnesium alloys, titanium, titanium alloys, copper, copper alloys, steel, steel alloys, iron, iron alloys, nickel, nickel alloys, and combinations thereof) and a non-parent material (e.g. one or more of oxides, metals, metallic compounds, non-metal/non-metallic compounds, chemical compounds, and/or nanomaterials) which are encased/entrained, embedded, and/or dispersed therein.

More specifically, in some embodiments, a member undergoes accumulative deformation (e.g. by continuous extrusion processing) and with each iteration, the level of redundant deformation on the product (or member) is increased and the fraction of embedded/entrained material (e.g. oxides, nanoparticles, and/or fibers) is also increased.

In one aspect, an extrusion is provided, comprising: a parent material comprising a metal and a non-parent material, wherein the non-parent material is different from the parent material, further wherein the non-parent material comprises a particulate form which is: embedded in the parent material and dispersed in the parent material.

In one aspect, a composite product is provided, comprising: an extrusion including a parent material and a non-parent material, wherein the parent material comprises a metal material; wherein the non-parent material comprises a particulate material embedded within the parent material and dispersed within the parent material, wherein the parent material is different from the non-parent material.

In some embodiments, the parent material is selected from the group consisting of: aluminum, aluminum alloy, magnesium, magnesium alloy, titanium, titanium alloy, copper, copper alloy, steel, steel alloy, iron, iron alloy, nickel, nickel alloy, and combinations thereof.

In some embodiments, the non-parent material comprises: a metal; a chemically oxidized parent material; a nanomaterial, a non-metallic material; and combinations thereof.

In some embodiments, the non-parent material (e.g. in the composite product) comprises: a metal material having an average particle size of not greater than about 1 micron.

In some embodiments, the non-parent material (e.g. in the composite product) comprises: a metal material having an average particle size of not greater than about 5 microns.

In some embodiments, the non-parent material comprises a material having an average particle size of not greater than about 100 nanometers.

In some embodiments, the non-parent material comprises a material having an average particle size of not greater than about 20 nanometers.

In some embodiments, the non-parent material comprises a non-metal fibrous particulate material (e.g. glass fiber, carbon fiber) having an average particle size of not greater than about 2 microns.

In some embodiments, the non-parent material is present in an amount not greater than about 10 vol. % in the composite product.

In some embodiments, the composite product is a rod.

In some embodiments, the composite product is a wire.

In one aspect, a composite product (e.g. an extruded wire) is provided, comprising: a parent material and a non-parent material, wherein the non-parent material comprises a layer surrounding and enclosing the parent material, wherein the parent material is different from the non-parent material, wherein the non-parent material comprises an electrically insulating material, further wherein the parent material comprises an electrically conductive material.

In one aspect, a system is provided comprising an extruder comprising a feed wheel and an extrusion die, wherein the feed wheel is configured to directed a feed stock including a plurality of members into an extrusion die (to be conformed); and a sprayer configured to attach to the extruder at a position adjacent to the feed wheel, wherein the sprayer is configured to spray the incoming feed stock with a surface treatment to define a coating on the surface of the plurality of members, wherein the coating comprises a different material than the plurality of members.

In some embodiments, the system includes a drier adjacent to the sprayer, wherein the drier is configured to dry the coating on the plurality of members prior to entry into the extrusion die.

In some embodiments, the extrusion die is configured to extrude the coated members to provide a composite material having non-parent material embedded within the parent material.

In some embodiments, the extrusion die is configured to provide a composite material having a diameter equal to that one of the plurality of members. In some embodiments, the members comprise the same diameter. In some embodiments, the extrusion die is configured to provide a composite product having a diameter which is greater than the diameter of the members. In some embodiments, the extrusion die is configured to provide a composite product having a diameter which is less than the diameter of the members.

In one aspect, a method, is provided, comprising: (a) providing a plurality of members comprising a parent material and a non-parent material, wherein the parent material is different from the non-parent material, wherein the non-parent material is present in not greater than about 15 vol. % of the members; and (b) extruding the plurality of members to form a composite product, wherein, via the extruding step, the composite product comprises a plurality of particles of the non-parent material, wherein the particles having an average particle size of not greater than about 5 microns, wherein the particles of non-parent material are embedded within the parent material.

In some embodiments, the providing step comprises: surface treating at least some of a plurality of individual members of a parent material to create a coating on at least some of the members, wherein the members comprise a parent material and the coating comprises a non-parent material, wherein the parent material is different from the non-parent material.

In some embodiments, the providing comprises: providing a group of individual members, including a plurality of members comprising a parent material and at least one member comprising a non-parent material, wherein the parent material is different from the non-parent material.

In some embodiments, the extruding step comprises: co-adding the parent members and non-parent members to the extruder.

In one aspect, a method is provided, comprising: (a) surface treating at least some of a plurality of individual members of a parent material to create a coating on at least some of the members, wherein the members comprise a parent material and the coating comprises a non-parent material, wherein the parent material is different from the non-parent material, wherein the coating includes a thickness of not greater than about 30 microns; (b) extruding the plurality members to form a composite product, wherein, via the extruding step, the composite product comprises a plurality of particles of the non-parent material, wherein the particles having an average particle size of not greater than about 1 micron, wherein the particles of non-parent material are embedded within the parent material.

In some embodiments, the surface treating step comprises surface treating all members.

In some embodiments, the members comprise the same diameter. In some embodiments, the members comprise different diameters.

In some embodiments, the extruding step comprises a composite product having the same diameter as a single member (e.g. each of the members have the same diameter). In some embodiments, the extruding step comprises a composite product having a diameter which is smaller than the diameter of the each of the members. In some embodiments, the extruding step comprises a composite product having a diameter which is larger than the diameter of the each of the members.

In some embodiments, the method comprises: (c) cutting the composite product into a plurality of composite product sections; and (d) repeating steps (a) and (b) to provide a composite product having an increased amount of non-parent material embedded within the parent material when compared to the composite product formed from a single pass of step (a) and (b).

In some embodiments, the method comprises: (c) repeatedly folding the composite product onto itself to define a bundle of composite sections having the same length; and (d) repeating steps (a) and (b) to provide a composite product having an increased amount of non-parent material embedded within the parent material when compared to the composite product formed from a single pass of step (a) and (b).

In some embodiments, the method further comprises: (c) cutting the composite product into a plurality of composite product sections; and (d) performing a second extruding step to create a second composite product having at least one of: (i) an increased amount of dispersion between the particles and (ii) a reduced average particle size as compared to the composite product formed in step b.

In some embodiments, the member comprises an elongated member. In some embodiments, the elongated member is configured to be fed into an extruder/configured for extrusion.

In some embodiments, the member comprises a wire.

In one aspect, a method is provided, comprising: (a) surface treating an exterior surface of at least some of a plurality of individual members to provide at least some coated members, wherein each member comprises a parent material; (b) extruding (e.g. continuously extruding) a plurality (e.g. bundle) of coated members and members to form a first composite member, wherein the composite member comprising a first ratio of parent material to non-parent material (e.g. coating); (c) surface treating an exterior surface of at least some of a plurality of composite members to provide at least some coated-composite members; and (d) extruding a plurality of (e.g. bundle) of composite members to form a second composite member, wherein the second composite member comprises a second ratio of parent material to non-parent material, wherein the first ratio is smaller than the second ratio.

In some embodiments, the surface treating is selected from the group consisting of: painting, electroplating, covering; anodizing, chemically reacting, depositing via chemical vapor deposition, and combinations thereof.

In one aspect, a composite product is provided, comprising: a parent material and a non-parent material, wherein the non-parent material is a different material than the parent material, wherein the parent material is configured to entrain the non-parent material, wherein the composite product is formed by feeding a plurality of parent material members and non-parent material members through an extruder.

In one aspect, a composite product is provided, comprising: a parent material and a non-parent material, wherein the non-parent material is a different material than the parent material, wherein the parent material is configured to entrain the non-parent material, wherein the composite product is formed by feeding a plurality of parent material members having a surface treatment of non-parent material through an extruder.

In some embodiments, the parent materials are surface treated (e.g. coated) with the non-parent materials.

In some embodiments, the non-parent materials comprise at least some members that are co-added to the extruder with the parent materials.

In some embodiments, the composite product is formed through multiple passes through an extruder.

In some embodiments, the parent material is an aluminum alloy.

In one embodiment, a composite product is provided. The composite product includes: a parent material entraining a non-parent material, wherein the composite product is formed through deformation (e.g. iterative continuous extrusion processing steps).

In one embodiment, a composite product is provided. The composite product includes: a parent material entraining a non-parent material, wherein the composite product is formed through accumulative deformation processing (e.g. iterative continuous extrusion processing steps) is an extrusion die.

In one embodiment, a composite product is provided. The composite product comprises: a parent material (e.g. aluminum alloy) and a second material (non-parent material) entrained therein, wherein the composite product is formed from (a plurality of accumulative) passes of extrusion (e.g. continuous extrusion), wherein, due to [the number of passes and nature (e.g. P, T) of] the accumulative passes of continuous extrusion, the composite product comprises: a target strength; a target thermal stability; and a target conductivity.

In one embodiment, a composite product is provided. The composite product comprises: a parent material (e.g. aluminum alloy) and a second material (non-parent material) entrained therein, wherein the composite product is formed from accumulative passes of continuous extrusion, wherein, due to the ratio of non-parent material to parent material in the composite product, the composite product comprises: a target strength; a target thermal stability; and a target conductivity.

In one embodiment, a composite product is provided. The composite product comprises: a parent material (e.g. aluminum alloy) and a second material (non-parent material) entrained therein, wherein the composite product is formed from accumulative passes of continuous extrusion, wherein, due to (1) [the number of passes and nature (e.g. P, T) of] the accumulative passes of continuous extrusion; and (2) the ratio (e.g. vol. %) of parent material to non-parent material; the composite product comprises: a target strength; a target thermal stability; and a target conductivity.

In one embodiment, a method is provided. The method comprises: (a) surface treating an exterior surface of at least some of a plurality of individual members, wherein each member comprises a parent material and further wherein the surface treatment comprises a non-parent material (e.g. material different from the parent material) to provide at least some coated members; and (b) extruding the plurality of members (including at least some coated members) to form a composite member, wherein the composite member includes a ratio of parent material to non-parent material.

In one embodiment, the parent material comprises a metal. In one embodiment, the parent material comprises aluminum. In one embodiment, the parent material comprises an aluminum alloy. In one embodiment, the parent material comprises magnesium. In one embodiment, the parent material comprises a magnesium alloy. In one embodiment, the parent material comprises titanium. In one embodiment, the parent material comprises a titanium alloy. In one embodiment, the parent material comprises copper. In one embodiment, the parent material comprises a copper alloy. In one embodiment, the parent material comprises steel. In one embodiment, the parent material comprises a steel alloy. In one embodiment, the parent material comprises iron. In one embodiment, the parent material comprises an iron alloy. In one embodiment, the parent material comprises nickel. In one embodiment, the parent material comprises a nickel alloy. In one embodiment, various parent materials are selected from two, three, four, five, six, seven, eight, nine, ten, or more various compositions of parent materials.

Non-limiting embodiments of the non-parent material (e.g. coating) include: an oxide layer; a metallic layer; a non-metallic layer; a paint layer; a nanoparticle layer; a chemical layer; and/or combinations thereof,

In one embodiment, steps (a) and/or (b) are repeated.

In one embodiment, the extruding step further includes feeding the plurality of members into an extruder (e.g. where the plurality of members are retained in a bundle).

In another aspect of the disclosure, a method is provided. The method comprises: (a) surface treating an exterior surface of at least some of a plurality of individual members, wherein each member comprises a parent material and further wherein the surface treatment comprises administering a non-parent material (e.g. different from the parent material) to at least some of the individual member to provide at least some (e.g. treated and/or coated members); (b) extruding a plurality (e.g. bundle) of treated members and members (untreated) to form a first composite member, wherein the composite member comprising a first ratio of parent material to non-parent material (e.g. coating); (c) surface treating an exterior surface of at least some of a plurality of composite members to provide at least some coated-composite members; and (d) extruding a plurality (e.g. bundle) of composite members to form a second composite member, wherein the second composite member comprises a second ratio of parent material to non-parent material, wherein the first ratio is larger than the second ratio.

In another aspect of the instant disclosure, a method is provided. The method includes: (a) selecting the target properties (e.g. strength, thermal stability, conductivity, ductility, toughness, and/or surface conditions) of a target composite product (e.g. aluminum alloy product); based on the target properties, selecting: (1) co-addition of a plurality of individual members of a parent material and at least some non-parent material (e.g. surface treatment of an exterior surface of at least some plurality of individual members or non-parent material individual member addition) and; (2) an extrusion process (e.g. @ a specified T, P) to form, from a plurality of individual members of parent material and the non-parent material, a composite member, wherein the composite member comprises a ratio of parent material to non-parent material.

In some embodiments, the method comprises selecting a number of iterations of steps (a) and/or (b) on the composite member formed in step (b); and wherein, based on (1), (2) and (3), the actual composite product corresponds to the target composite product.

In some embodiments, the surface treatment comprises administering a non-parent material (e.g. oxide layer, metallic layer, non-metallic layer, chemical layer) to the individual member to provide at least some coated members.

In one embodiment, the method comprises performing multiple (accumulative) extrusions (e.g. on wire members), resulting in a composite product (article). In some embodiments, multiple extrusions comprise exhibiting severe plastic deformation in the composite product.

In one embodiment, a parent material usable in one or more methods of the present disclosure is made by the following process. The parent material is cast, followed by continuous rolling (or extrusion) to form a rod. Optionally, the rolled (or extruded) product is solution heat treated and quenched (e.g. if the parent material is a heat treatable alloy). In one embodiment, a rod is made into a wire. As non-limiting examples, the rod is made into the wire through one or more of: drawing, conforming (a continuous extrusion operation); and/or otherwise reducing the cross sectional area of the rod into a wire.

As non-limiting examples, the parent materials (individual members) are in the form of: rods, wires, bars, rolled/folded sheet(s) or the like.

In some embodiments, the plurality of parent materials comprise the same alloy. In some embodiments, the plurality of parent materials comprise different alloys (e.g. different aluminum alloys, different non-aluminum alloys, and combinations thereof). In some embodiments, the members comprise aluminum alloys and non-aluminum alloys. Non-limiting examples of non-aluminum alloys include: iron and steel alloys, copper alloys, titanium alloys, and nickel alloys.

In one embodiment, the method comprises surface treating a plurality of parent materials (e.g. an aluminum alloy member) to propagate a coating (e.g. an oxide layer) on the surface of each of the parent materials.

In some embodiments, the plurality of parent members comprise the same surface treatment (e.g. same coating). In some embodiments, the plurality of parent members comprise a different surface treatment (e.g. two or more coatings).

In some embodiments, the coating comprises an oxide layer; a non-metallic compound, a metallic compound, a nanomaterial layer, and/or other chemical compounds or species.

In some embodiments, the parent material comprises a sufficient oxide layer without a surface treatment (e.g. through oxidation at ambient conditions).

In accordance with one or more embodiments of the instant disclosure, surface treatments are provided to create a coating on a surface of a member. In one embodiment, the surface treating step comprises: propagating and/or growing non-parent material (e.g. oxides) on exterior of the individual member (e.g. the parent material). In one embodiment, the surface treatment step comprises administering a high temperature surface treatment (e.g. by growing oxides in heated atmospheric air). In one embodiment, the surface treatment step comprises precipitating oxides through chemical vapor deposition (CVD). In one embodiment, the surface treatment step comprises precipitating oxides on the parent metal through physical vapor deposition. In one embodiment, the surface treatment step comprises growing oxides on the parent metal by administering an anodic bath (e.g. an acid) to the parent material. In one embodiment, the surface treatment step comprises growing oxides on the parent metal by administering one or more coatings to the parent material (e.g. surface treatment). In one embodiment, the surface treatment step comprises electroplating the parent material. In one embodiment, the surface treatment step comprises electroless plating the parent material (i.e. without current). In one embodiment, the surface treatment step comprises plasma spraying the parent material. In one embodiment, the surface treatment step comprises plasma thermal spraying the parent material. In one embodiment, the surface treatment step comprises administering a slurry application to the parent material (e.g growing the oxides by running the parent material through an adhering medium followed by an oxide dispersion to adhere the oxides to the surface of the parent material). In one embodiment, the surface treatment step comprises administering oxides to the surface of the parent material. In some embodiments, the surface treatment step comprises coating the parent material with a metallic coating (e.g. metallic coating is different from the parent material).

In some embodiments, prior to any of the aforementioned surface treatment and/or growing steps, the parent material undergoes a thermal treatment. In some embodiments, the coated parent material undergoes a thermal treatment prior to undergoing deformation (conforming).

As some non-limiting examples, the surface treating step results in a coating having a thickness that is: not greater than about 50 microns; not greater than about 40 microns; not greater than about 30 microns; not greater than about 25 microns; not greater than about 20 microns; not greater than about 15 microns; not greater than about 10 microns; not greater than about 5 microns; not greater than about 2 microns; not greater than about 1 micron; not greater than about 0.5 microns; or not greater than about 0.1 micron. As some non-limiting examples, the surface treating step results in a coating having a thickness that is: at least about 50 microns; at least about 40 microns; at least about 30 microns; at least about 25 microns; at least about 20 microns; at least about 15 microns; at least about 10 microns; at least about 5 microns; at least about 2 microns; at least about 1 micron; at least about 0.5 microns; or at least about 0.1 micron.

In some embodiments, after undergoing a surface treatment, the plurality of surface treated members (parent materials) are simultaneously reduced (e.g. in an adjacent position to one another) such that a final composite product is formed from the plurality of surface treated parent materials. In one embodiment, the step of forming of a composite product comprises continuously reducing (e.g. through a continuous extrusion process) the plurality of coated members. In some embodiments, the forming step comprises continuous deformation (e.g. incremental strain) across the output of the composite product.

In one embodiment, the cross-sectional area of the composite product is lower than the sum of the cross-sectional area of each of the plurality of coated parent materials. In one embodiment, the extrusion ratio (input cross-sectional area to output cross-sectional area) is: at least about 1:1; or at least about 5:1; or at least about 10:1; or at least about 20:1; or at least about 30:1; or at least about 50:1; or at least about 75:1; or at least about 100:1. In one embodiment, the extrusion ratio (input cross-sectional area to output cross-sectional area) is: at least about 1:1; or at least about 1:2; or at least about 1:3; or at least about 1:4; or at least about 1:5; or at least about 1:6; or at least about 1:7; or at least about 1:8; or at least about 1:9; or at least about 1:10.

In one embodiment, the extrusion ratio (input cross-sectional area to output cross-sectional area) is: not greater than about 1:1; or not greater than about 5:1; or not greater than about 10:1; or not greater than about 20:1; or not greater than about 30:1; or not greater than about 50:1; or not greater than about 75:1; or not greater than about 100:1. In one embodiment, the extrusion ratio (input cross-sectional area to output cross-sectional area) is: not greater than about 1:1; or not greater than about 1:2; or not greater than about 1:3; or not greater than about 1:4; or not greater than about 1:5; or not greater than about 1:6; or not greater than about 1:7; or not greater than about 1:8; or not greater than about 1:9; or not greater than about 1:10.

In one embodiment, the cross-sectional area of the composite product is greater than the sum of the cross-sectional area of each of the plurality of coated parent materials. In one embodiment, the cross-sectional area of the composite product is the same as than the sum of the cross-sectional area of each of the plurality of coated parent materials. In one embodiment, the cross-sectional area of the composite product is approximately the same as than the sum of the cross-sectional area of each of the plurality of coated parent materials.

In some embodiments, the plurality of coated members are bundled (twisted together or otherwise fixably attached to one another) prior to undergoing a deformative process (e.g. reduction in cross sectional area).

In some embodiments, the cross-sectional pattern of entrained particulates is defined by the input procedures (e.g. bundling pattern, propagation of oxides/coating on parent material, extrusion/die used, to name a few). As a result, the cross-section varies (e.g. the ratio and/or dispersion of the parent material to the coated material). In some embodiments, the volume fraction of the particulate is controllable through the thickness of the layer onto the parent material. In some embodiments, the volume fraction of the particulate is controllable through the number of passes (e.g. bundles and total reduction) through the deformation/reduction process.

In some embodiments, the cross-sectional shape of the product is the same. In some embodiments, the cross sectional shape of the product varies. Non-limiting examples of the cross-sectional shape of the composite product (and/or coated parent material) comprise: a rectangular shape, a square shape, a cylindrical shape, an oblong shape, and/or other polygonal shapes.

In some embodiments, after the forming of a composite product, the surface treating (e.g. coating) step is repeated on the surface of each of a plurality of composite products, followed by another forming step (e.g. continuous extrusion).

In some embodiments, after the forming of a composite product, a plurality of composite products are put adjacent to one another and undergo a second forming step (e.g. no surface treatment prior to the second forming step).

In some embodiments, the method is reiterated/repeated (i.e. to step 2 and/or 3) until the final composite product exhibits a severe plastic deformation microstructure, characterized by grain sizes less than one micron and/or dislocation densities.

In some embodiments, the method is reiterated/repeated (i.e. to step 2 and/or 3) until the final composite product comprises a threshold content of coating material (e.g. non-parent material) entrained in the composite.

In some embodiments, the method is reiterated/repeated (i.e. to step 2 and/or 3) until the final composite product comprises physical properties comprising: an ultimate tensile strength; an elongation; a yield strength/tensile yield strength; a micro grain structure; conductivity; and/or combinations thereof,

In some embodiments, the presence of oxides in the parent material (or final composite) impacts the resulting micro grain structure.

In some embodiments, the composite product comprises: wire, rod, fastener rod, fasteners, wire cords, and/or valve bodies. In one embodiment, the composite product comprises an aluminum alloy high-voltage transmission conductor. In one embodiment, the composite product comprises a fastener,

In some embodiments, the number of passes (e,g. through the continuous extrusion process) is based on the amount of severe plastic deformation desired in the final product. Non-limiting variations of the above-referenced methods include: bundling/not bundling members; number of passes; amount of pressure; die shape; temperature of plurality of members/plurality of composite products (e.g. input to and/or during extrusion), to name a few.

Thus, through one or more of the present methods, a final composite product is producible with: a target strength; a target conductivity; and a target thermal stability.

In some embodiments, the present method(s) provide for solid state processing of metal materials (e.g. with metallic or non-metallic materials.) In some embodiments, the method(s) provide for mechanical alloying in solid state.

In some embodiments, the instant methods comprise providing severe plastic deformation in a metal (wire) material. In some embodiments, the method(s) produce wire products which are configured to exhibit severe plastic deformation. In some embodiments, the methods produce wire producing having ultrafine grain sizes (Hall-Petch strengthening). In some embodiments, the grain sizes are less than about 500 microns.

In some embodiments, the instant methods retard the recovery and recrystallization processes (Zener Drag mechanism) (e.g. by dispersed particles to gain thermal stability). In some embodiments, the methods provide for grain boundary engineering in the wire product (i.e. through solute redistribution).

In some embodiments, the methods provide for incorporation of extrinsic materials into metal wires (e.g. orowan loops) which provide properties that are not within the parent metal (e.g. composite strengthening).

In some embodiments, the wire product comprises embedded non-parent materials. In some embodiments, the wire product comprises dispersed non-parent materials. In some embodiments, the wire product comprises non-parent materials which have a small average particle size.

In some embodiments, the method disperses non-parent material, embeds non-parent material, and/or reduces the average particle size of the non-parent material in the final wire product.

In some embodiments, the strength (e.g. yield strength, tensile strength, elongation) are increased (e.g. via non-parent material addition and/or severe work hardening via the extrusion die pass(es)).

In some embodiments, the wire product comprises a high electrical conductivity (e.g. improved over the parent material) by minimizing use of solid solution elements in the wire product and/or by incorporating a non-parent material having increased electrical conductivity over the parent material.

In some embodiments, the wire product comprises an electrical product (e.g. automotive wire, automotive parts, transmission wires, distribution wires); products of specialty alloys (e.g. weld wire); and/or rod (fastener stock, master alloy rod, machine stock, mixed metal composite). In some embodiments, wire products with anodized materials are configured to provide large hard particles in the final product. In some embodiments, wire products incorporating non-parent materials which are electroplated (e.g. Cu, Ni) are configured to provide mechanical alloying and precipitation in the final wire product. In some embodiments, wire products including non-metallic fibers as non-parent materials (e.g. glass and carbon fibers) are configured to provide mixed metal composite materials. In some embodiments, wire product having nanoparticles therein are configured to provide an improved strength over the parent material. In some embodiments, wire product comprising alloying elements (e.g. foil) as the non-parent material is configured to provide dispersion strengthening.

Various ones of the inventive aspects noted hereinabove may be combined to yield one or more various embodiments of the instant disclosure.

These and other aspects, advantages, and novel features of the disclosure are set forth in part in the description that follows and will become apparent to those skilled in the art upon examination of the following description and figures, or may be learned by practicing the disclosure.

### BRIEF DESCRIPTION OF THE DRAWINGS

FIG. 1 is a flow chart depicting an embodiment of a method in accordance with the instant disclosure.

FIG. 2 is a flow chart depicting another embodiment of a method in accordance with the instant disclosure.

FIGS. 3A-3F depict various cross-sectional views of a coated parent member in accordance with various embodiments of the instant disclosure.

FIG. 4 depicts cross-sectional views of one embodiment of a plurality of composite members (left) and an individual composite member (right) in accordance with the instant disclosure.

FIG. 5 depicts cross-sectional views of one embodiment of a plurality of composite members with a coating on the surface of each (left) and a final composite product (right) in accordance with the instant disclosure.

FIGS. 6A-6L depict various cross-sectional views of the composite product in accordance with various embodiments of the instant disclosure.

FIG. 7A depicts a schematic view of a plurality of coated members undergoing the forming step (e.g. continuous deformation/continuous extrusion) with a reduction in cross-sectional area, in accordance with one or more methods of the instant disclosure.

FIG. 7B depicts a schematic view of a plurality of coated members undergoing the forming step (e.g. continuous deformation/continuous extrusion) with no reduction in cross-sectional area, in accordance with one or more methods of the instant disclosure.

FIG. 7C depicts a schematic view of a plurality of coated members undergoing the forming step (e.g. continuous deformation/continuous extrusion) with an increase in cross-sectional area, in accordance with one or more methods of the instant disclosure.

FIG. 8-25 are directed towards the Examples section and reference experimental data completed in accordance with one or more aspects of the instant disclosure,

FIG. 26 depicts a schematic of an embodiment of an extruder in accordance with the instant disclosure.

FIG. 27 depicts another embodiment of a wire product in accordance with the instant disclosure, in which an outer layer forms a laminate or coating around an inner layer, where the outer and inner layers are different materials having different chemical, physical, and/or mechanical properties.

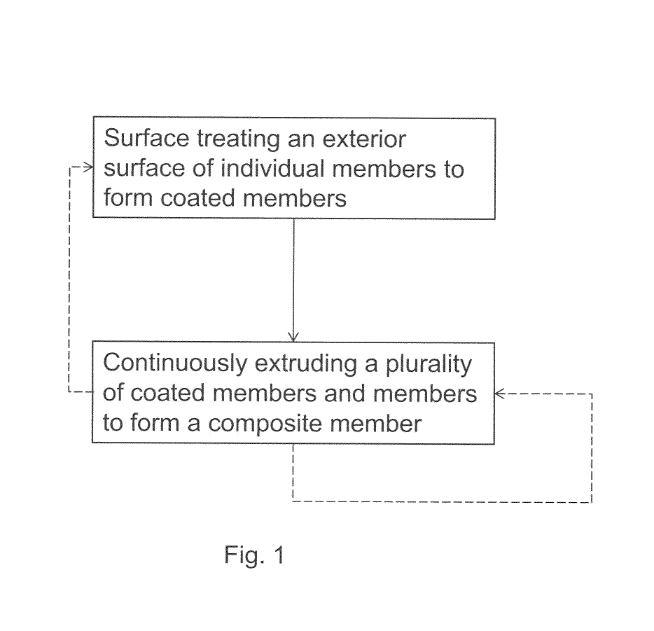

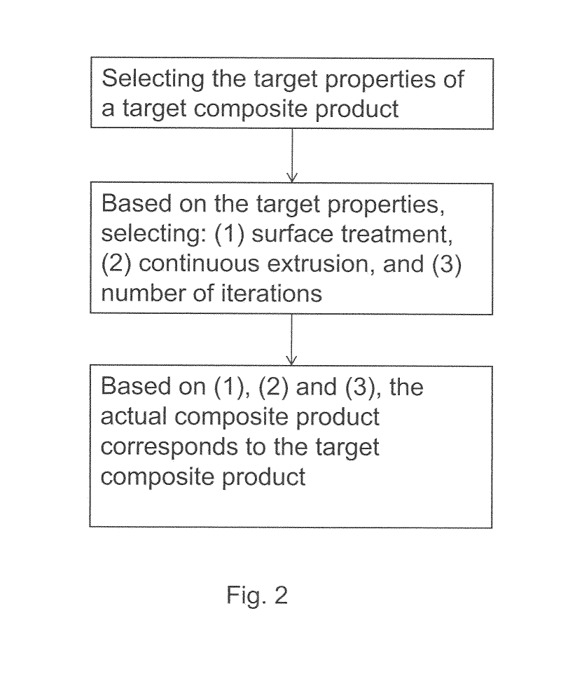

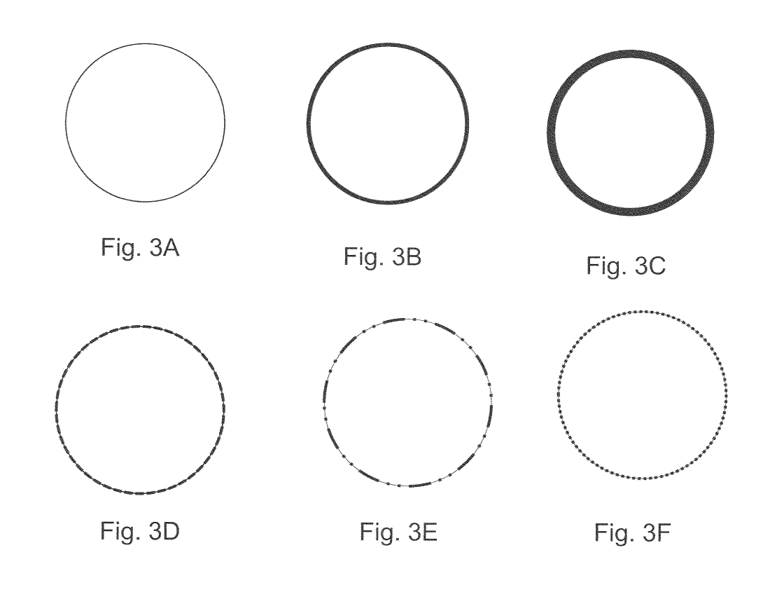

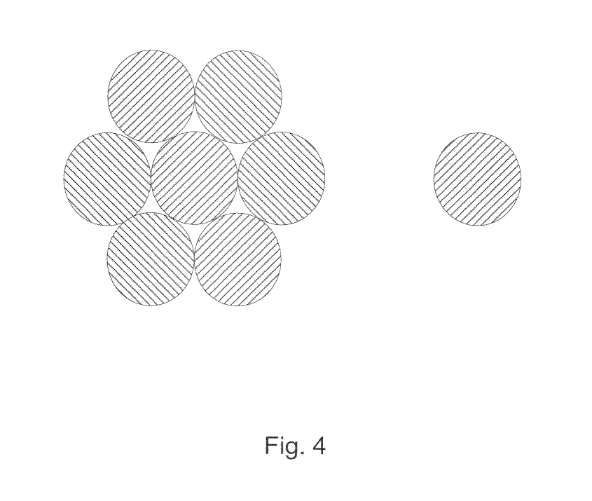

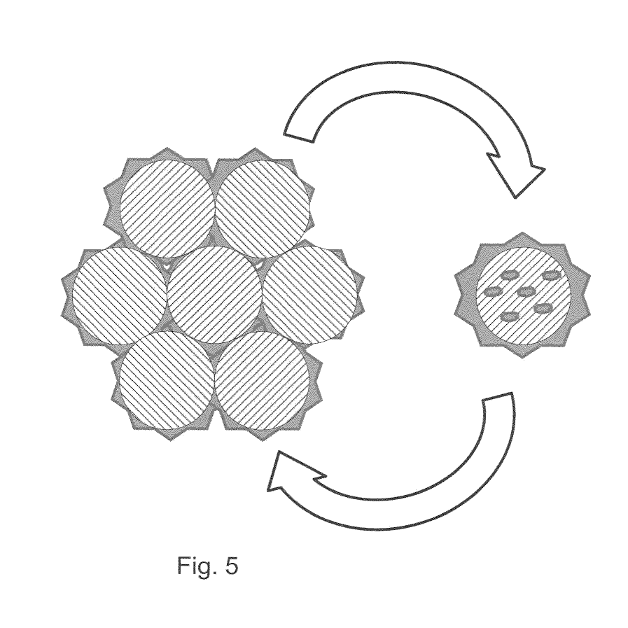

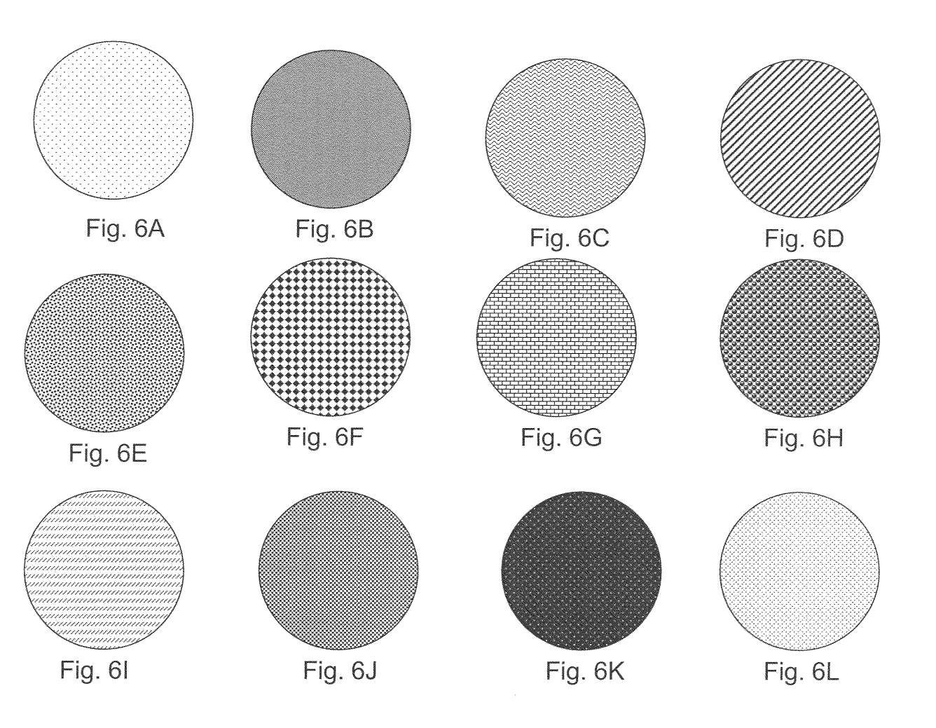

### DETAILED DESCRIPTION

The following definitions are provided:

As used herein, “metal” means elemental substance that is a good conductor of heat and electricity. In some non-limiting embodiments, the parent material is a metal.

As used herein, “alloy” means: a substance with metallic properties, composed of two or more chemical elements of which at least one is a metal. More specifically, an aluminum alloy is a substance with aluminum and one or more other elements, produced to have certain specific characteristics.

In some embodiments, the alloy is a solution heat treatable alloy. Non-limiting examples of solution heat treatable alloys include: Aluminum Association alloys 2xxx series alloys, 6xxx series alloys, 7xxx series alloys, or 8xxx series alloys.

In some embodiments, the aluminum substrate is a non-solution heat treatable alloy. Some non-limiting examples of these types of alloys include: Aluminum Association alloys 3xxx series alloys and 5xxx series alloys.

As used herein, “grow” means: to increase in size, number, or degree

As used herein, “propagate” means: to cause to increase in number or amount,

As used herein, “extrude” means: to form a material (e.g. metal) with a desired cross section by forcing it through a die.

As used herein, “entrained” means: to trap an object within another material,

As used herein, “composite” means something made up of disparate or separate parts or elements.

As used herein, “oxide” means a compound in which oxygen is bonded to one or more electropositive atoms. Some non-limiting examples of oxides include: those compounds that form naturally upon aluminum alloys (such as Al₂O₃, MgO, and mixed metal spinel compounds) as well as those formed by the oxidation of other metals and their oxides.

As used herein, “compound” means composed of two or more parts, elements, or ingredients.

As used herein, “nanoparticle” means: a particle in which size (diameter, length, dimension) is quantified in terms of nanometers. As a non-limiting example, a nanoparticle comprises an average particle diameter of 2 nm to 100 nm. As some non-limiting examples, the average particle size of the nanoparticles are: at least about 2 nm; at least about 5 nm; at least about 10 nm; at least about 15 nm; at least about 20 nm; at least about 30 nm; at least about 40 nm; at least about 50 nm; at least about 60 nm; at least about 70 nm; at least about 80 nm; at least about 90 nm; or at least about 100 nm.

As some non-limiting examples, the average particle size of the nanoparticles are: not greater than 2 nm; not greater than 5 nm; not greater than 10 nm; not greater than 15 nm; not greater than 20 nm; not greater than 30 nm; not greater than 40 nm; not greater than 50 nm; not greater than 60 nm; not greater than 70 nm; not greater than 80 nm; not greater than 90 nm; not greater than 100 nm, or greater.

As used herein, “nanofiber” means, a fiber having nanoparticulate properties (i.e. an aspect ratio from 1:1 to 1:10⁶ and larger).

As used herein: “carbon nanotubes” (CNTs) refers to cylinders made up of pure carbon molecules with unique properties. In some embodiments, the cylinders are single-walled. In some embodiments the cylinders have a plurality of walls (in other words, multi-walled). In some embodiments, CNTs may be metallic or semi-conducting (depending, for example, on the chirality of the CNTs).

As used herein, “enclosed” means surrounded on all sides.

As used herein, “parent material” means: the material of the individual member. In some non-limiting embodiments, the parent material comprises: aluminum, an aluminum alloy, magnesium, a magnesium alloy, titanium, a titanium alloy, copper, a copper alloys, steel, a steel alloy, iron, an iron alloy, nickel, a nickel alloy, and combinations thereof.

As used herein, “fraction” means: a number that compares part of an object or a set with the whole,

As used herein, “cross-section” means: of or pertaining to a cross-section (e.g. a cut-away side view taken across a perpendicular plane to of an object (e.g. axial and/or longitudinal).

As used herein, “diameter” means: the width of a circular or cylindrical object.

As used herein, “profile” means: an outline of an object, formed on a vertical plane passed through the object at a right angle to one of its principal horizontal dimensions.

As used herein, “wire” means: a solid wrought product that is long in length in relation to its small cross-sectional dimensions.

As used herein, “rod” means: a solid wrought product that is long in relation to its circular cross section.

As used herein, “product” means: a thing produced by or resulting from a process.

As used herein, “bundle” means: several objects or a quantity of material gathered or bound together.

As used herein, “wrought product” means: a product that can begin as raw material castings and has been subjected to mechanical working by processes such as rolling, extruding, and forging to the extent that all remnants of the cast metallurgical structure have been removed.

As used herein, “plurality” means: two or more of something.

As used herein, “pattern” means: a distinctive form of marking. In some embodiments, patterns of the composite product are uniform or non-uniform.

As used herein, “integrated” means: to bring together or incorporate (parts) into a whole.

As used herein, “filament” means a very fine thread or threadlike structure.

As used herein, “striations” means: a stripe or streak in a material.

As used herein, “dispersed” means: to become scattered.

As used herein, “dispersoid” means: an object that has become scattered.

As used herein, “deformation” means: to put an object out of shape.

As used herein, “redundant deformation” means: repeatedly putting an object out of shape.

As used herein, “accumulative deformation” means the additive effect of repeated/redundant deformation.

As used herein, “severe plastic deformation” (SPD) refers to a process which imparts strength in an object by performing redundant plastic deformation. In some embodiments, SPD results in microstructural refinement and/or unique metallic structures. In some embodiments, mechanical property improvements by SPD processing are limited due to: (1) dynamic recovery of the microstructure; and/or (2) thermal exposure of SPD enhanced products can result in a rapid loss of the enhanced properties.

As used herein, “corresponds” means to be in agreement and/or conformation with. As a non-limiting example, the composite (actual) product has one or more properties (e.g. strength, thermal stability, conductivity, ductility, toughness, surface conditions, and/ or ratio of parent material to non-parent material) that corresponds to the target composite product. As non-limiting examples, a composite product (actual) has properties identical to the target composite product, or within about 5%; or within about 10%; or within about 15%; or within about 20%; or within about 25%; or within about 30%; or within about 35%; or within about 40%; or within about 45%; or within about 50%.

As used herein, “target” refers to a goal. In one non-limiting example, a target composite product means the composite product having one or more specified (targeted) properties. Non-limiting properties include: thermal stability, strength, ductility, toughness, surface conditions, and/or conductivity.

As used herein, “composite product” (or actual composite product) means: a material having at least two components herein. As some non-limiting examples, composite products are provided in one or more embodiments of the instant disclosure (e.g. including one or more properties: thermal stability, strength, ductility, toughness, surface conditions and/or conductivity). In one embodiment, the composite product comprises a parent material and a non-parent material.

In some embodiments, the non-parent material is: less than about 50 vol. % of the composite product; less than about 40 vol. % of the composite product; less than about 30 vol. % of the composite product; less than about 25 vol. % of the composite product; less than about 20 vol. % of the composite product; less than about 15 vol. % of the composite product; less than about 10 vol. % of the composite product; less than about 5 vol. % of the composite product; or less than about 1 vol. % of the composite product. In some embodiments, the non-parent material is: less than about 0.8 vol. % of the composite product; less than about 0.6 vol. % of the composite product; less than about 0.5 vol. % of the composite product; less than about 0.4 vol. % of the composite product; less than about 0.2 vol. % of the composite product; less than about 0.15 vol. % of the composite product; less than about 0.1 vol. % of the composite product; or less than about 0.05 vol. % of the composite product.

In some embodiments, the non-parent material is: not greater than about 50 vol. % of the composite product; not greater than about 40 vol. % of the composite product; not greater than about 30 vol. % of the composite product; not greater than about 25 vol. % of the composite product; not greater than about 20 vol. % of the composite product; not greater than about 15 vol. % of the composite product; not greater than about 10 vol. % of the composite product; not greater than about 5 vol. % of the composite product; or not greater than about 1 vol. % of the composite product. In some embodiments, the non-parent material is: not greater than about 0.8 vol. % of the composite product; not greater than about 0.6 vol. % of the composite product; not greater than about 0.5 vol. % of the composite product; not greater than about 0.4 vol. % of the composite product; not greater than about 0.2 vol. % of the composite product; not greater than about 0.15 vol. % of the composite product; not greater than about 0.1 vol. % of the composite product; or not greater than about 0.05 vol. % of the composite product.

As used herein, “thermal stability” means: that a material is microstructurally stable following exposures to various temperatures (thermal conditions).

As used herein, “strength” means: one or more of tensile yield strength, limit strength, or ultimate tensile strength, to name a few.

As used herein, “conductivity” means: the ability of a material to conduct electricity.

As used herein, “accumulate” means to gather or collect, often in degrees.

As used herein, “deformation” means: the act of deforming.

As used herein, “accumulative wire deformation” (sometimes called AWE) means: the act of deforming, completed in degrees (e.g. multiple passes). In some embodiments, AWE is completed with an extrusion die. In some embodiments, AWE results in severe plastic deformation in the resulting material passed through the extrusion die. In some embodiments, AWE is configured to incorporate non-parent materials (e.g. surface coatings, surface treatments, co-additions, and or co-bundled materials) with parent materials (e.g. resulting in an embedded product, a dispersed product, and/or reduction in average size—particle or grain size—of the non-parent material).

As used herein, “conform” means: to make multiple materials or objects into a similar form. As one non-limiting example, the extrusion die conforms multiple wires and/or multiple materials into a single, similar form (i.e. a wire product).

As used herein, “extrusion” means: a material or object that is the product of extrusion.

As used herein, “extruding” means: to form (e.g. metal and/or non-metal materials) with a desired cross section by forcing it through a die.

As used herein, “conform extrusion” means: a product of extrusion in which multiple materials/objects are made into a similar form (e.g. a single wire product having multiple materials therein).

As used herein, “non-parent material” means: a material which is not the parent material. In some embodiments, the non-parent material refers to the surface coating, surface plating, surface treatment, co-added/co-bundled materials (fibers) which are added to parent material to form a wire product (e.g. composite wire product).

As used herein, “surface coating” means: a coating along at least a portion of a surface. In some embodiments, the surface coating completely surrounds and covers the surface. In some embodiments, the surface coating partially covers (covers some parts and does not cover some other parts) of the surface.

As used herein, “embedded” means: to fix something into a surrounding mass.

As used herein, “dispersed” means: to spread a material into another material or object. In some embodiments, dispersed includes homogeneously dispersing. In some embodiments, dispersing including inhomogenously dispersing.

As used herein, “particle reduction” means: a reduction in a particle size (e.g. average particle size).

### EXAMPLES

### Prophetic Example

### Identifying and Selecting Candidate Alloys for Use as Members

To identify candidate alloys for the embodiments of the present disclosure, certain characteristics may be taken into consideration. Some of these non-limiting characteristics include: castability; response to Severe Plastic Deformation (SPD); post-SPD manufacturability; electrical conductivity; and/or corrosion resistance. After a candidate alloy is selected, it may be case into a billet (e.g. 270 mm diameter). Candidate alloys will then be extruded (e.g. into to 9.5 mm rod form) as a surrogate for continuous rod rolling. Extruded products (e.g. rods) will be continuously coiled; solution heat treated; quenched; and characterized. Subsequently, coils (e.g. 100 kg coils) of each candidate alloy will undergo Equal Channel Angular Pressing by Conform (ECAP-C). The coils will be repeatedly processed and sampled at progressive passes to determine the microstructural evolution in response to increasing strain.

After being subjected to SPD processing, the rods will be subsequently drawn and reduced. The effect of aging practices on the microstructure and particularly on the solute distribution near grain boundaries and subgrain boundaries will evaluated using transmission electron microscopy (TEM) and atom probe tomography (APT).

Candidate rod and wire products will be mechanically tested and subjected to electrical conductivity testing. These performance criteria will be related back to the microstructures using the analysis data, including but not limited to: tensile properties (e.g. yield strength, tensile strength, uniform elongation and total elongation); response to thermal exposure (e.g. tensile properties following service exposures up to 150° C.); electrical conductivity (e.g. ambient temperature conductivity testing); and/or corrosion resistance (e.g. Accelerated salt and/or humidity exposure testing).

### Comparative Prophetic Example

Evaluate one or more embodiments of the instant disclosure compared to an example of conductive wire material (e.g. AA6201-T84). Evaluation variables (e.g. performance metrics) include one or more of: tensile strength greater than 500 MPa; electrical conductivity greater than 54% IACS; and/or strength retention of greater than 80% following 1 hour at 150° C.

### Prophetic Example

### Accumulative Rod Forming and Extrinsic Particle Entrainment

Trials will be completed on coils of each candidate alloy (e.g. 100 kg coil of each candidate alloy). For example, accumulative rolling trials will be conducted to determine the effect of extrinsic fibers and nano-particles (primarily oxides) on the strength and stability of the structures formed. Additional processing will be performed using ECAP-C. Coils will be processed and sampled at progressive passes to determine the microstructural evolution in response to increasing strain. Candidate rod performance criteria will be related back to the microstructures using: tensile properties (e.g. yield strength, tensile strength, uniform elongation and total elongation); response to thermal exposure (e.g. tensile properties following service exposures up to 150° C.); corrosion resistance (e.g. Accelerated salt and/or humidity exposure testing).

### Examples of Composite Product Formation and Characterization

A set of experiments was performed to complete accumulative wire deformation on various types of parent materials and non-parent materials (surface coatings). Specifically, the tests included conform extrusion of: (1) pure aluminum wire; (2) surface coated aluminum wire via plating; (3) surface coated aluminum wire via solgel; (4) aluminum wire and strands of non-metallic materials (e.g. glass fiber) and (5) aluminum wire (AA8011) from foil. The experiments were performed to determine whether and to what extend the conform extruder, through accumulative deformation (e.g. wire deformation or AWE): (a) embeds non-parent material/surface coatings into the resulting product wire; (b) disperses the non-parent or surface coatings into the resulting product wire; and/or (c) reduces the particle size of the non-parent material/surface coating in the product wire,

### Equipment:

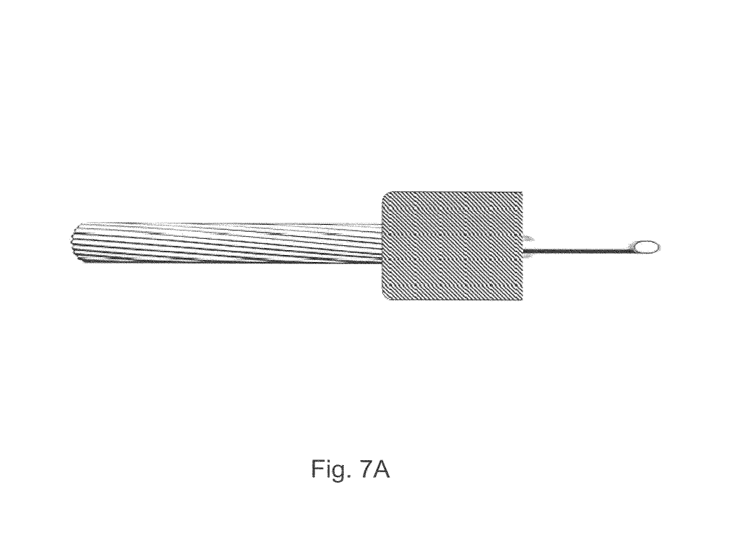

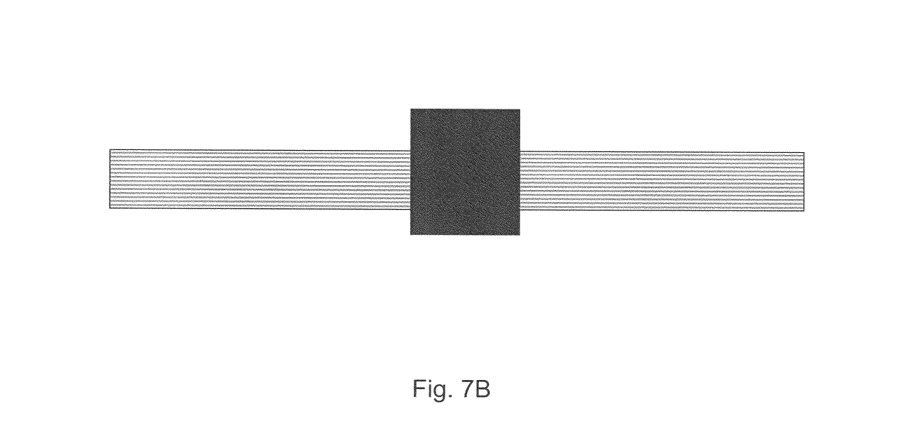

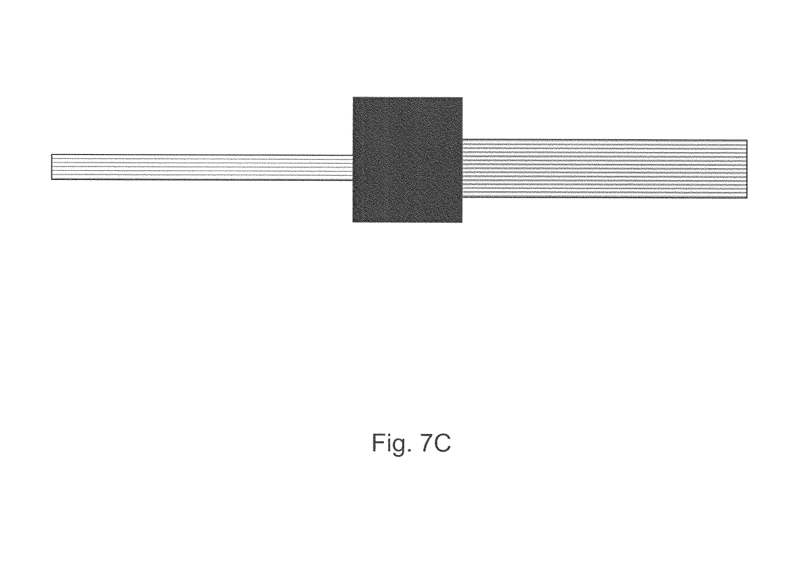

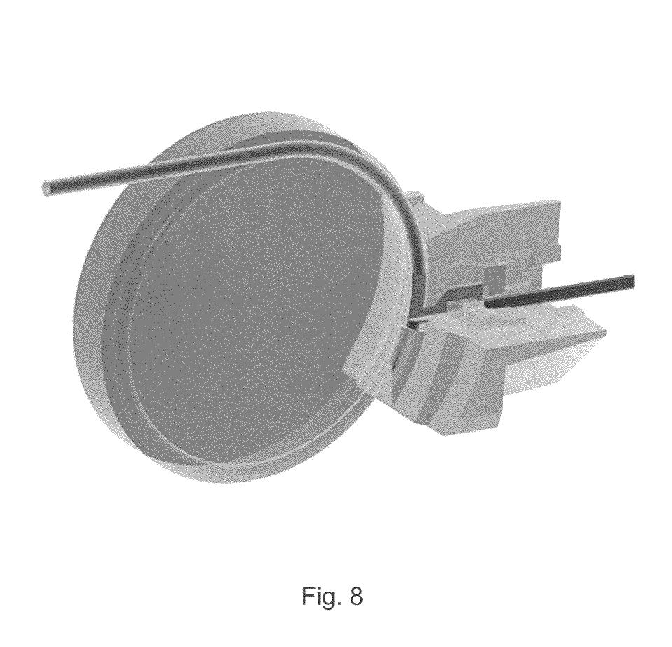

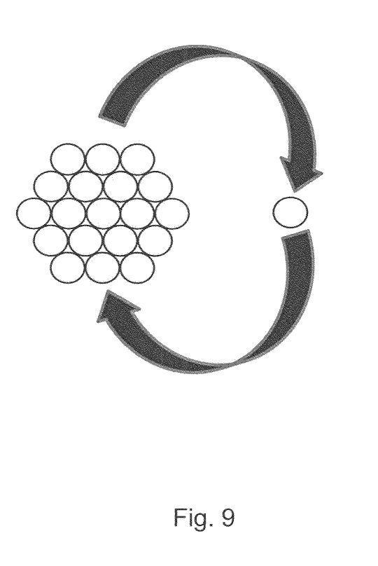

Referring to FIG. 8, a schematic of the instrument used to perform conform extrusion is depicted. The extruder included a wheel with a feed track/central groove (where the wire rests until it is fed through the extruder) and a dye which performs the extrusion. For these experiments, a die as depicted in FIG. 7A was utilized. While the extruder was fed over the top of the wheel (as shown in FIG. 8) another embodiment is to feed the wire bundle through the bottom of the wheel.

The extruder was configured such that a wire bundle of 19 wires was grouped and passed through the extruder to form a single wire (output wire/wire product). Via the die, the extrusion ratio was 19:1 per pass with unidirectional deformation. After the wire left the extrusion die, the wire was quenched with water. As a function of the extruder operating conditions, including friction in the die and the speed at which the wires were fed, the extruded material experienced a time-temperature profile of room temperature to 400° C. to room temperature in approximately 5 seconds. Multiple passes were completed, through different materials had differing total numbers of passes. For example, with five (5) passes of the accumulative reduction (i.e. 19⁵), the total ratio of reduction of an original wire (of the 19 wires) compared to the size of the original wire in the final product was 2.5 million:1 (e.g. the equivalent of extruding a 12 ft diameter billet extruded to 2 mm wire).

### General Procedure:

A wire is cut into 19 sections, and passed through the extruder. After a first pass, the wire is cut into 19 sections and again passed through the extruder. If a surface preparation/surface coating or non-metallic strand(s) of material is used with the initial wire (first AWE) no subsequent preparation/coating/non-metallic strands were added in for subsequent AWE passes for these experiments.

### AA 1350 (Pure Aluminum)

Bare AA 1350 having natural oxide layer thereon underwent 5 accumulative wire deformations (5 passes through the extruder). The experimental procedure and operating conditions of the extruder were confirmed to work.

AA1350 with Anodized Surface

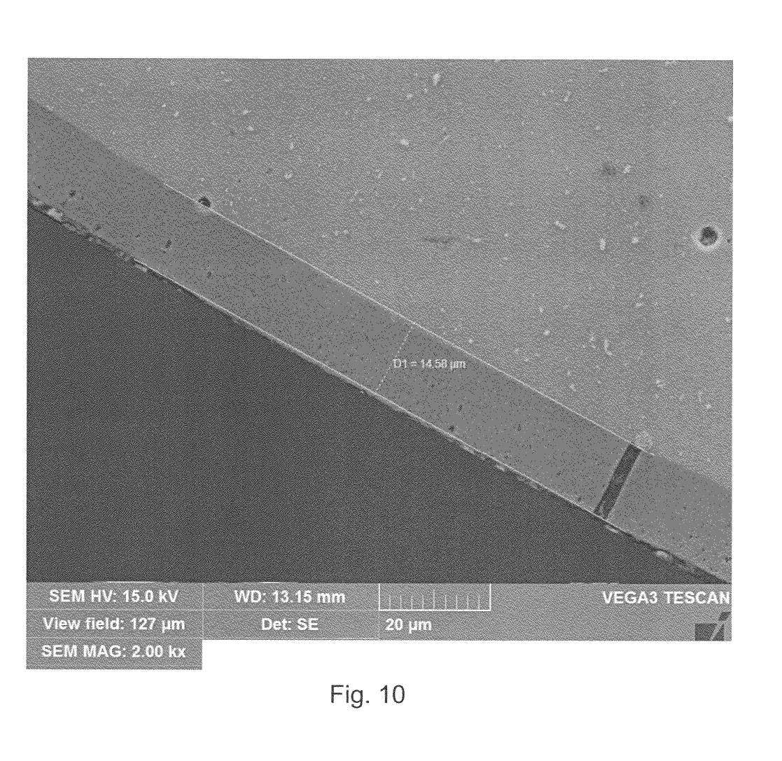

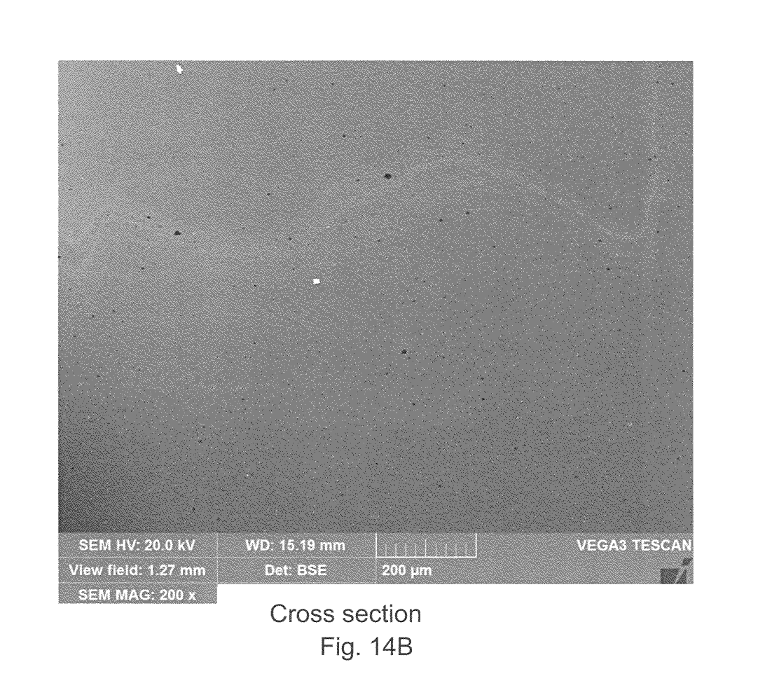

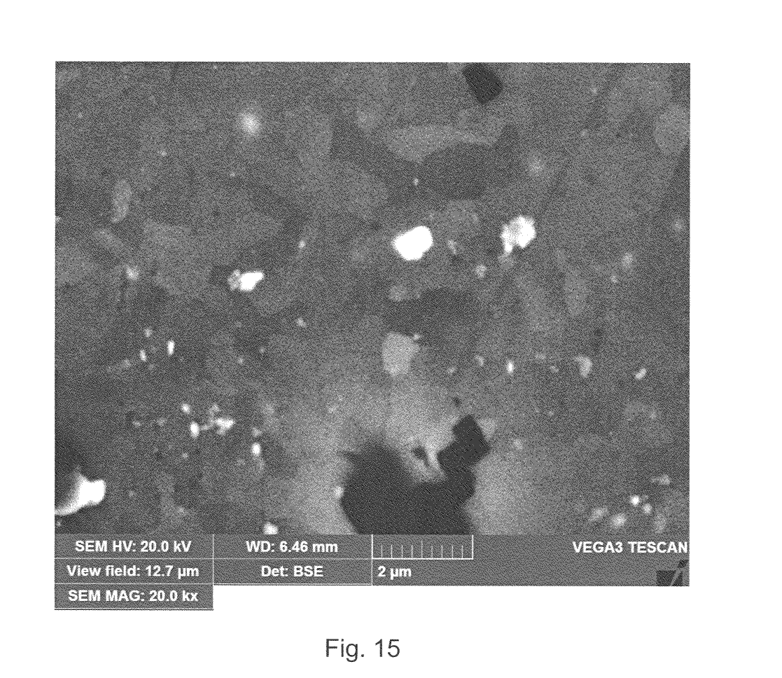

AA1350 was anodized to provide an anodized layer not greater than approximately 20 microns thick on the surface of the A1350. FIG. 10 depicts the anodized (oxide) surface coating on the aluminum prior to AWE. The wires were dried to remove excel moisture at elevated temperature (e.g. above ambient). Anodized 1350 underwent four AWEs. Upon inspection, the resulting anodized 1350 composite wire depicted embedded particles in the cross section of the wire and dispersed particles. The anodized layer (approximately 20 micron particle size before AWE) was reduced to particles approximately 1 micron in size after 1-2 passes, but did not reduce further in size. FIGS. 14A and 14B depict the various sections of the bare AA1350 wire after 5 passes/AWEs. FIG. 14A is the longitudinal section, while FIG. 14B is the cross section. It both sections, it is noted that no porosity is observable in the material. FIG. 15 is an SEM image depicting the contrast (black/white) from the difference in grain orientation in the wire product material. It was observed that grain sizes ranged from 500 nm to 2 microns.

AA1350 with Electroplating (e.g. Copper and Nickel)

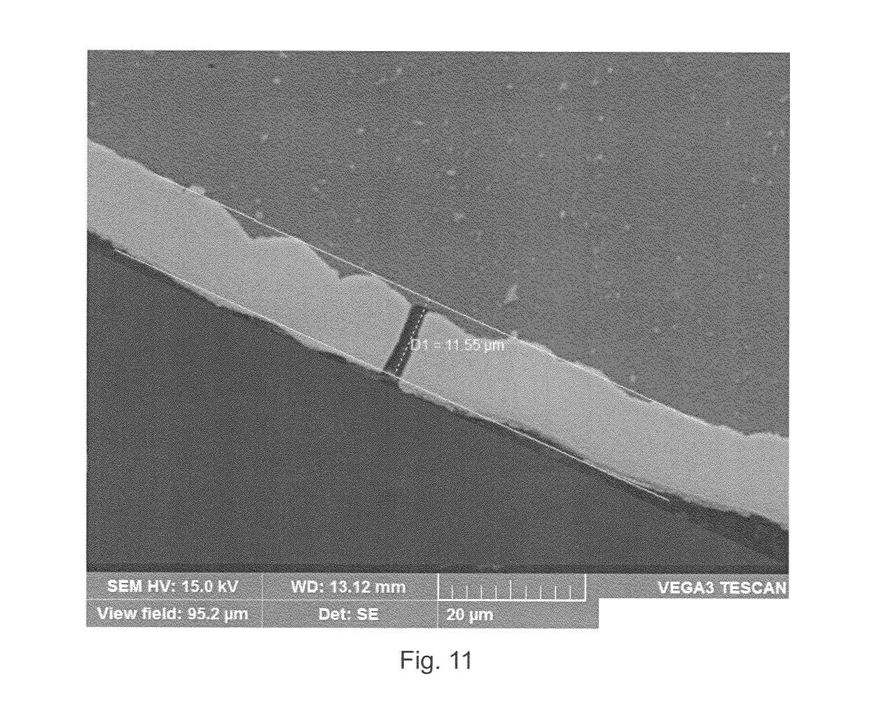

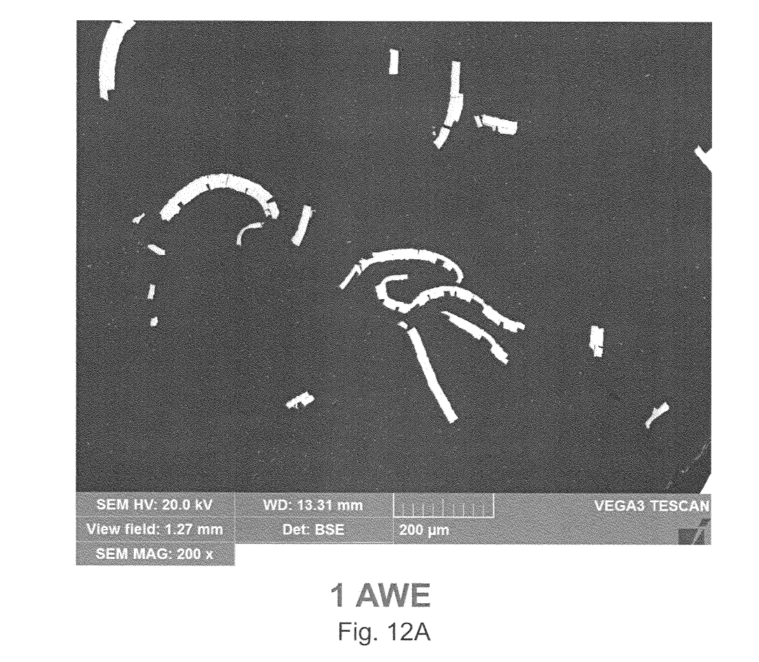

AA1350 wire underwent an electroplating process to yield an electroplated coating approximately 10-15 microns thick (either Ni or Cu material). FIG. 11 depicts the electroplated nickel layer on the surface of the aluminum. The same process outlined above was completed on a nickel plated AA1350 and a copper plated AA1350 wire. The nickel plated AA1350 underwent 5 AWEs, while the copper plated AA1350 underwent 2 AWEs. Upon inspection, the resulting composite wire depicted embedded particles in the cross section of the wire and dispersed particles. The electroplated layer (approximately 10-15 microns thick before AWE) was reduced to particles approximately 1 micron in size after 1-2 passes, but did not reduce further in size.

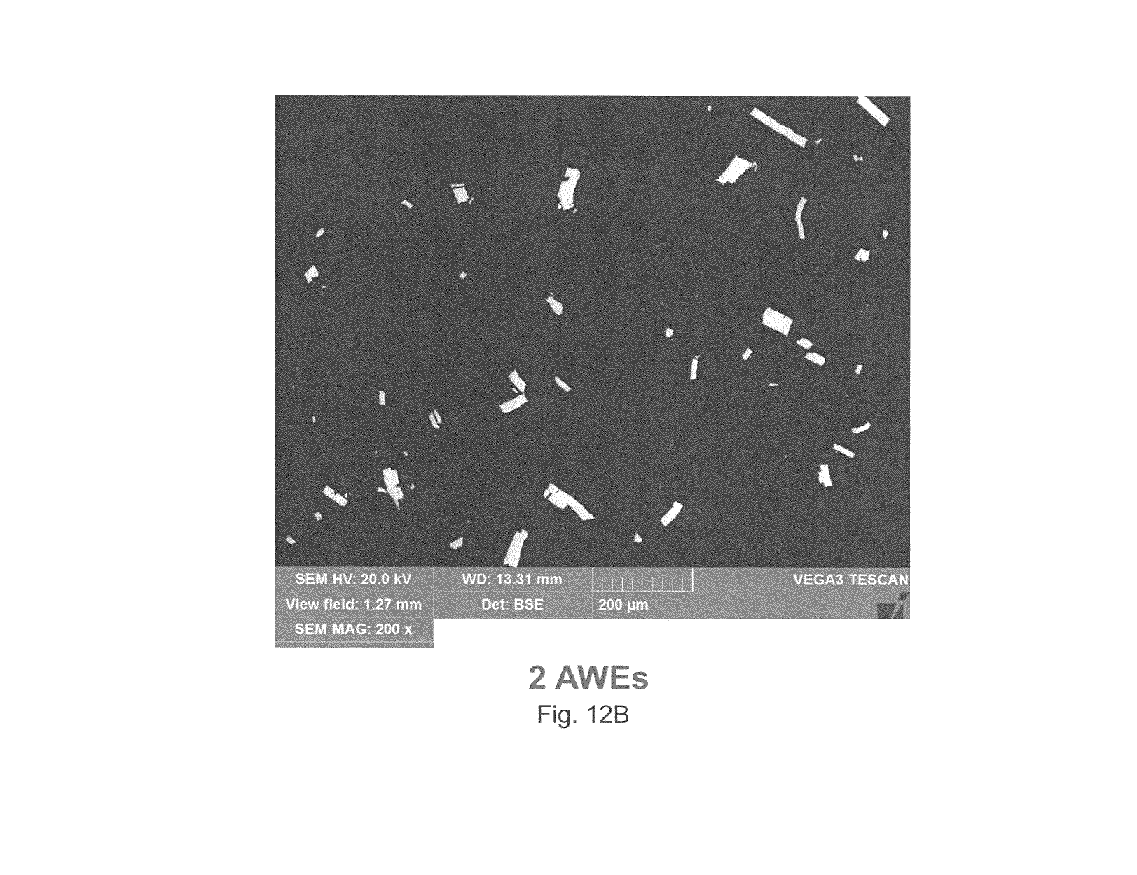

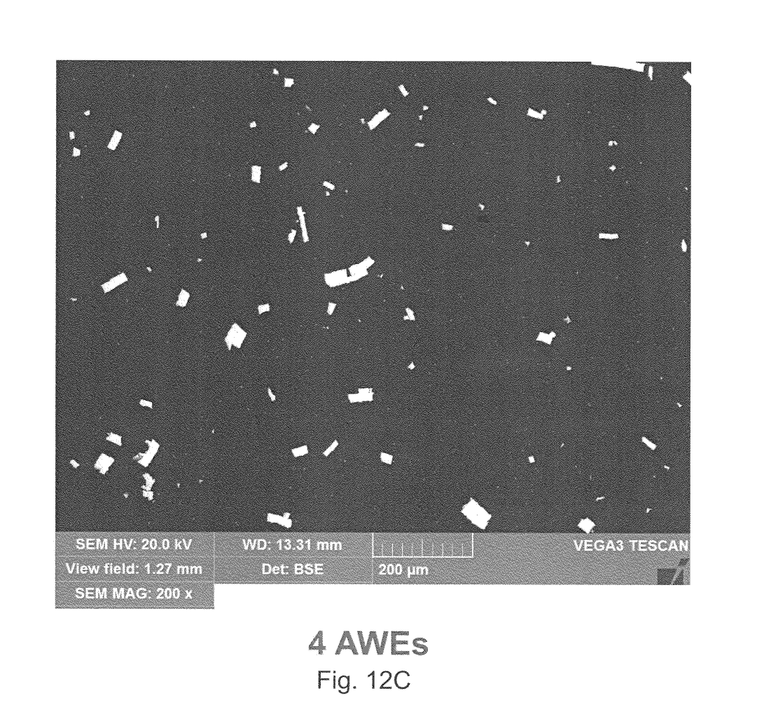

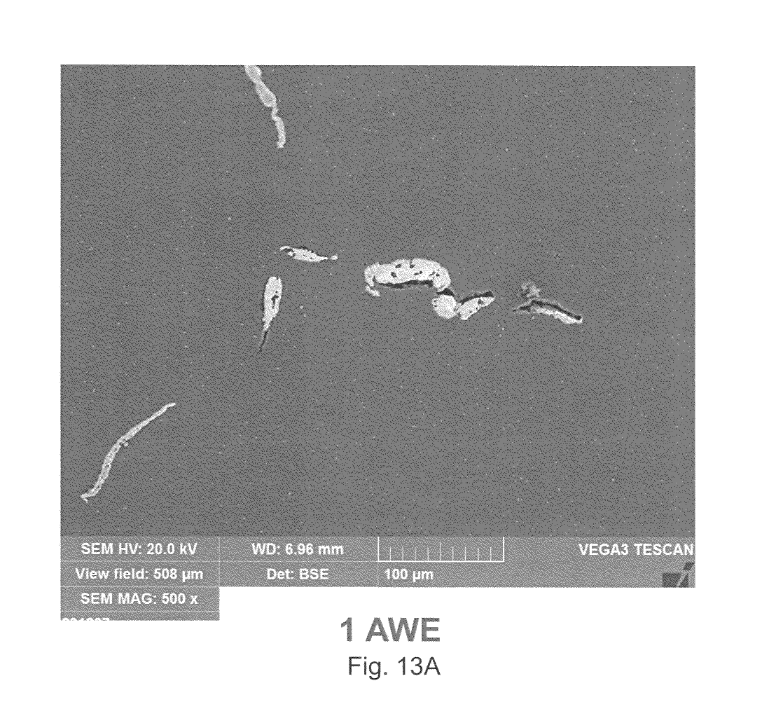

FIG. 12A through 12C are SEM images which depict the evolution of nickel plating in response to AWE (12A=1 pass, 12B=2 passes, 12C=4 passes). Without being bound to a particular mechanism or theory, it was observed that the electroplating broke up lengthwise but did not break up into smaller submicron size parties.

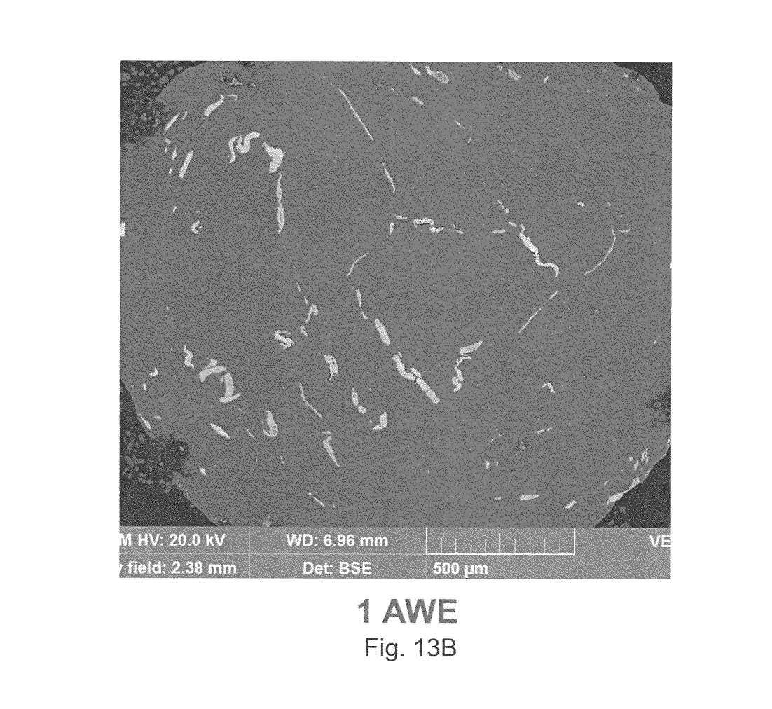

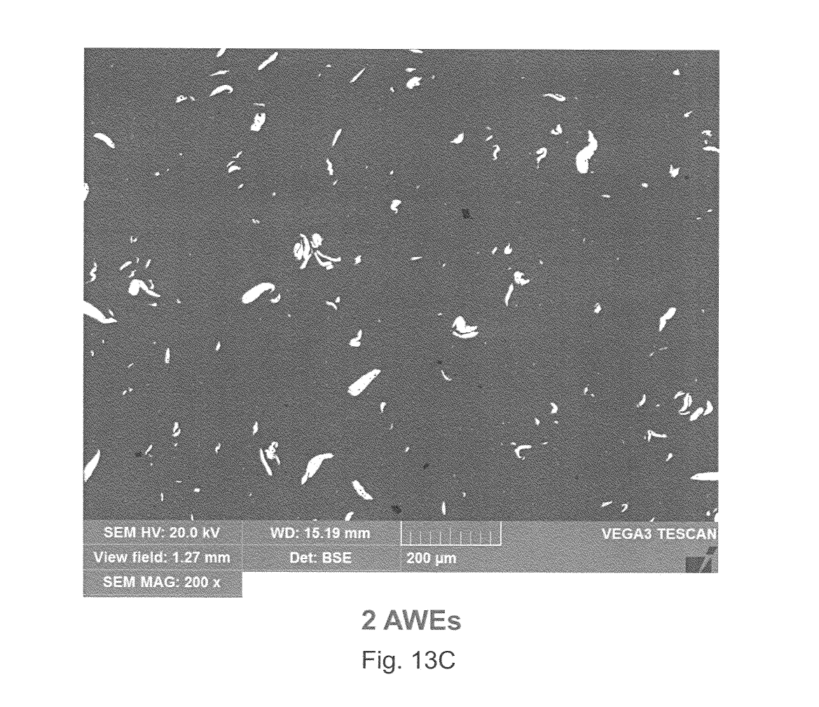

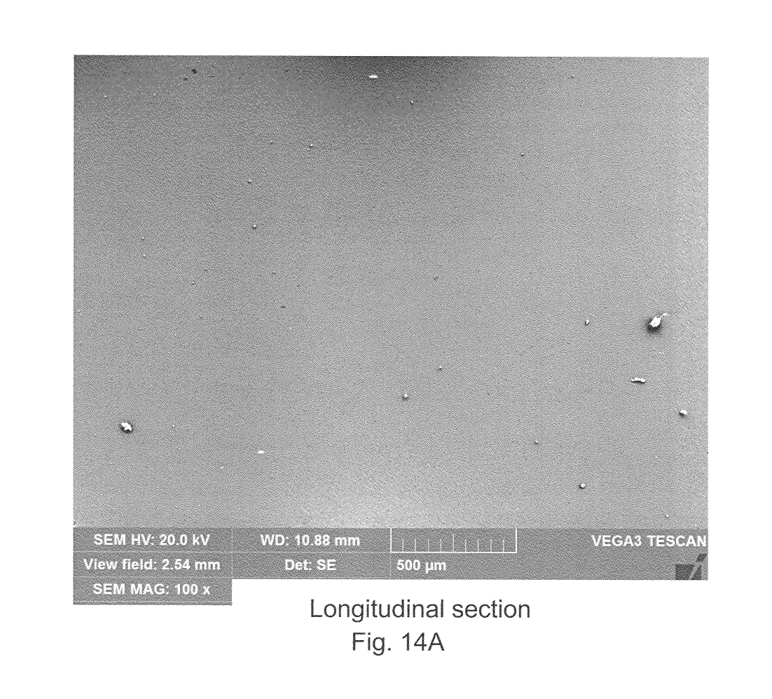

FIG. 13A through 13C are SEM images which depict the evolution of nickel plating in response to AWE (13A, 13B after one pass at different magnification levels, 13C after two passes). Without being bound to a particular mechanism or theory, it was observed that the electroplating broke up lengthwise and was deformed, but did not reduce to substantially smaller, submicron sized particles.

AA1350 with Non-Metallic Fibers (e.g. Glass Fiber and Carbon Fiber)

AA1350 and approximately 2 vol. % carbon fiber present (as a strand) with wires of AA1350 for the AWE pass. The material underwent 1 AWE. AA1350 and approximately 2 vol. glass fiber present (as a strand) with wires of AA1350 for the AWE pass. The material underwent 1 AWE. It was observed that Al increases in length (e.g. due to its ductility) as it is extruded, while the fibers do not extend in length. Upon inspection, it was confirmed that both wires (i.e. the glass fiber wire and the carbon fiber wire) were embedded and dispersed in the final wire product.

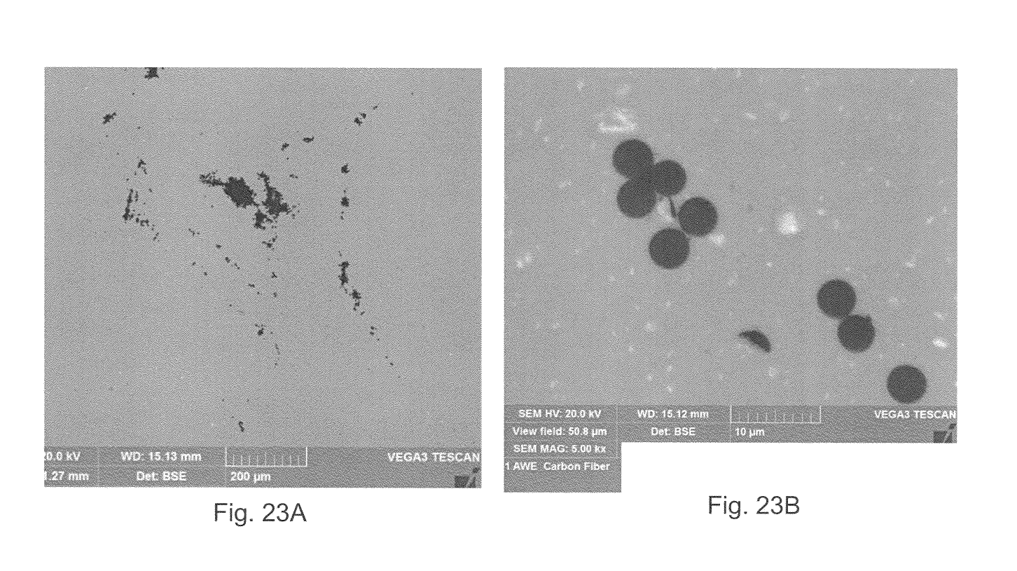

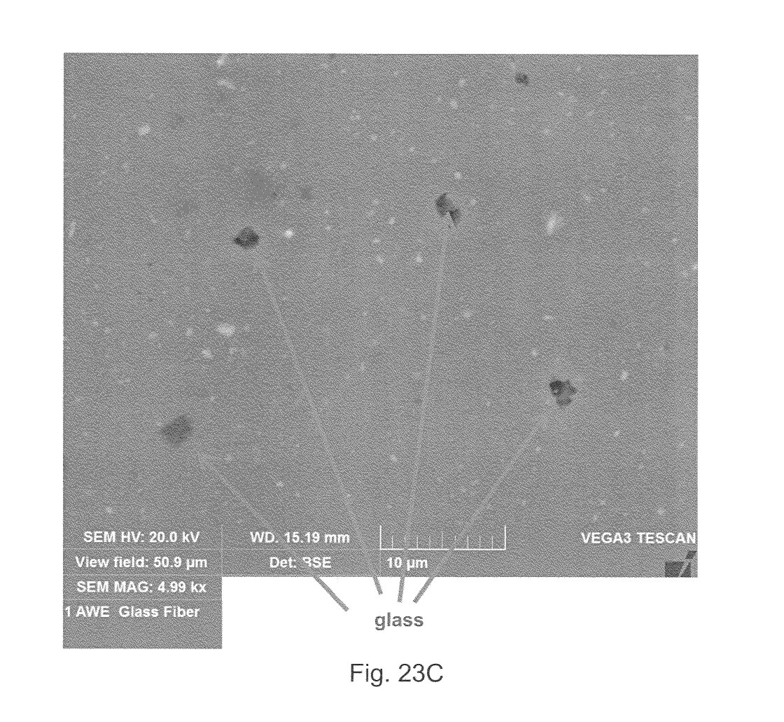

Referring to FIGS. 23A, 23B, and 23C, SEM images of the graphite wire product (23A, 23B) and glass wire product (23C) are depicted, showing embedded and dispersed particles.

AA 1350 with Nanomaterial Surface Coating (e.g. Alumina Particles in Solgel)

AA1350 was surface coated with alumina nanoparticles having an average size of 10 nm. Approximately 1 vol % of ethanol based solgel having nanoparticles therein was painted/etched onto the AA1350 wire (while the nanoparticles were suspended in the liquid). The solvent dried, leaving a white paint on the wires and each wire was wrapped with foil to enclose the nanopaint onto each wire. AA 1350 with a surface coating of nanoparticles underwent 2 AWEs. It was confirmed that the particles were both embedded and dispersed into the final wire product (i.e. a single, melded wire).

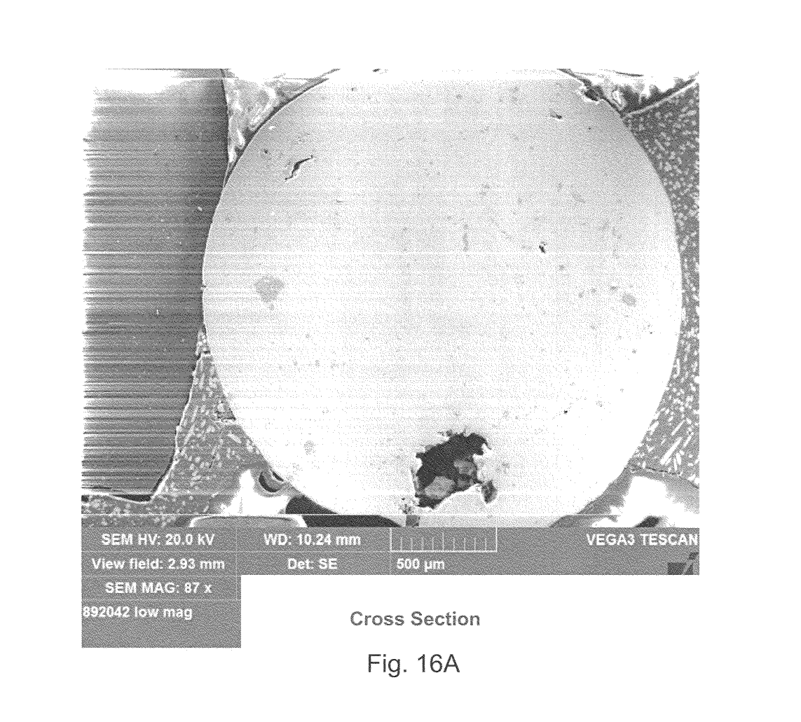

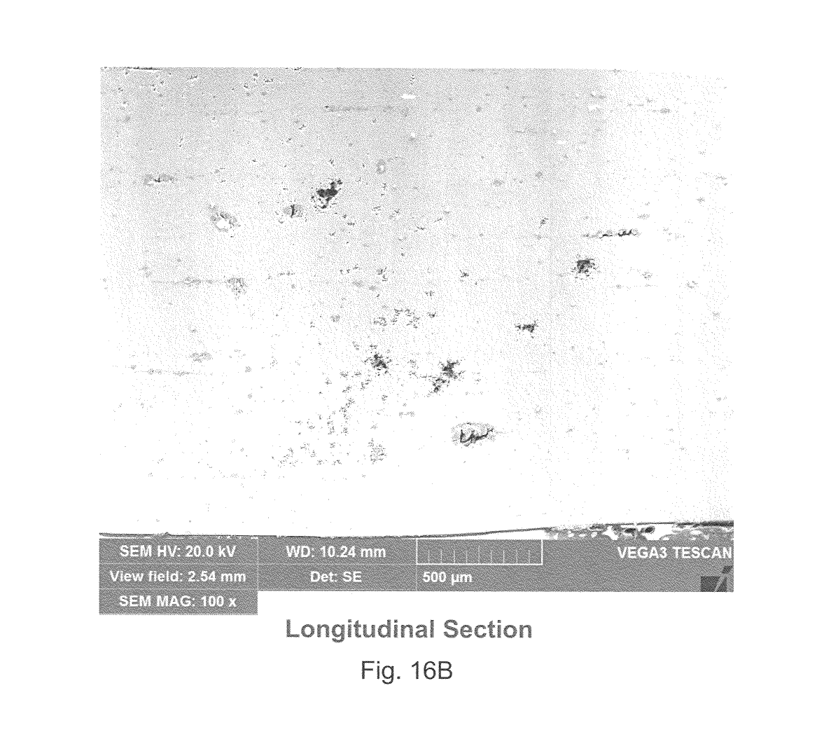

Referring to FIGS. 16A and 16B, a cross section (16A) and a longitudinal section (16B) at different magnifications are depicted. Also depicted in FIG. 16B is some observable porosity, which, without being bound by a particular mechanism or theory, is believed to be caused by excessive surface loading from the nanoparticle material (e.g. due to the power requirements on the conform extruder).

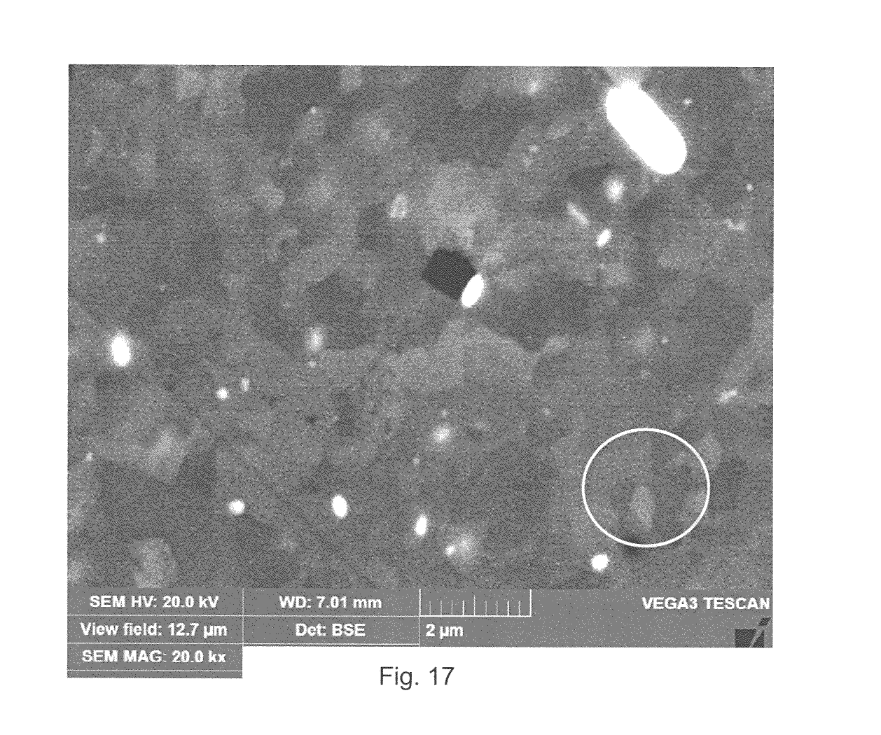

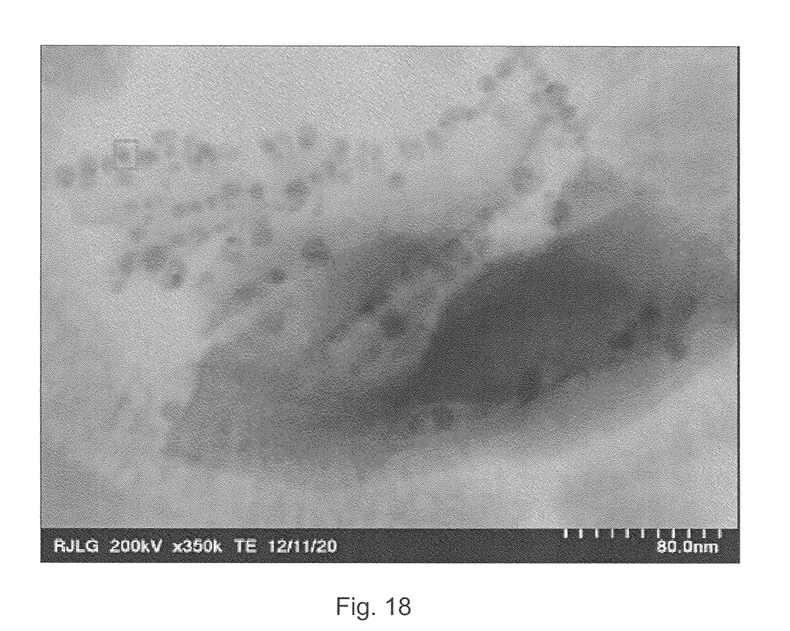

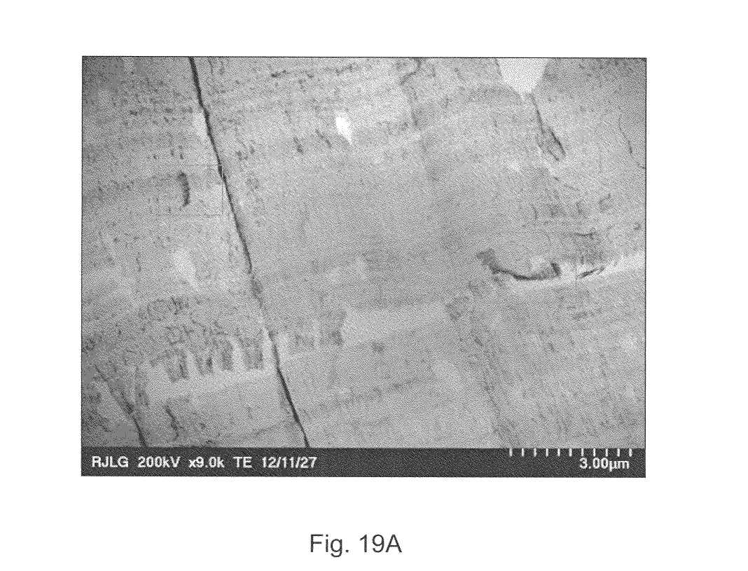

Referring to FIG. 17, an SEM image depicts the channeling contrast (black/white) due to different grain orientations. It was observed that the grain sizes varied from about 500 nm to about 2 microns. Referring to FIG. 18, a TEM image of the final wire product is provided, showing the alumina nanoparticles embedded in the aluminum matrix (parent material).

Alloyed Starting Material Without Surface Treatment (e.g. Aluminum Foil Scrap AA8011)

AA8011 foil scrap is approximately 6 μm thick with a thermal oxide layer (Al203) of a few angstroms thick/approximately 3 nm on each sheet. The foil was stacked into books and then circular foil stacks were punched out. The punch-outs were stacked, sintered, and extruded to form 2 mm wire. The oxide layer made up approximately 0.1 wt. % of the resulting wire. It was confirmed that the particles were both embedded and dispersed into the final wire product (i.e. a single, melded wire).

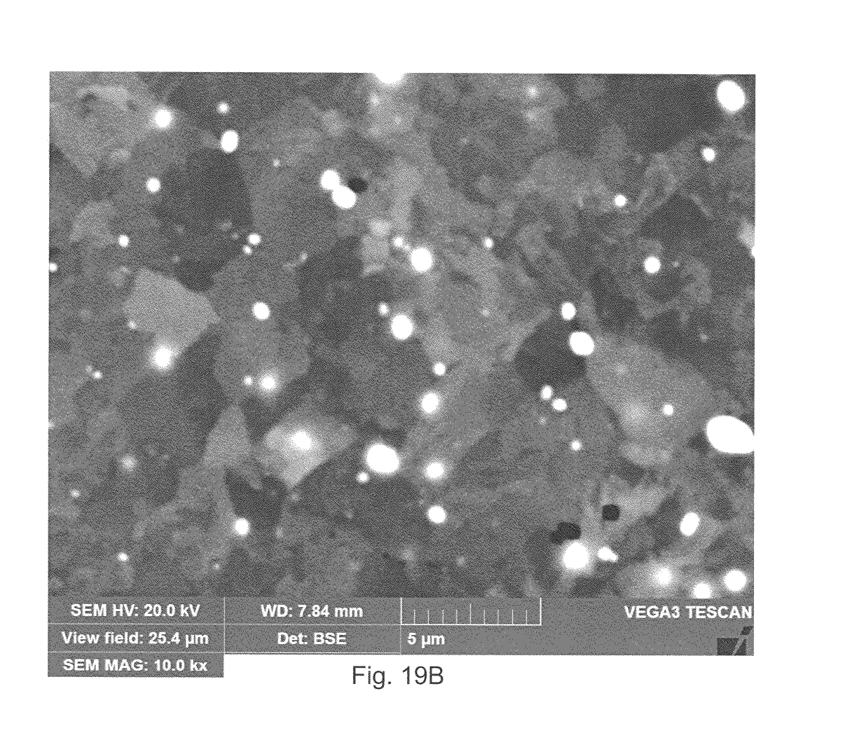

Referring to FIG. 19A, a TEM of the final wire product is provided. Referring to FIG. 19B an SEM of the final wire product is provided, depicting the channeling contrast due to the different grain orientations in the final product.

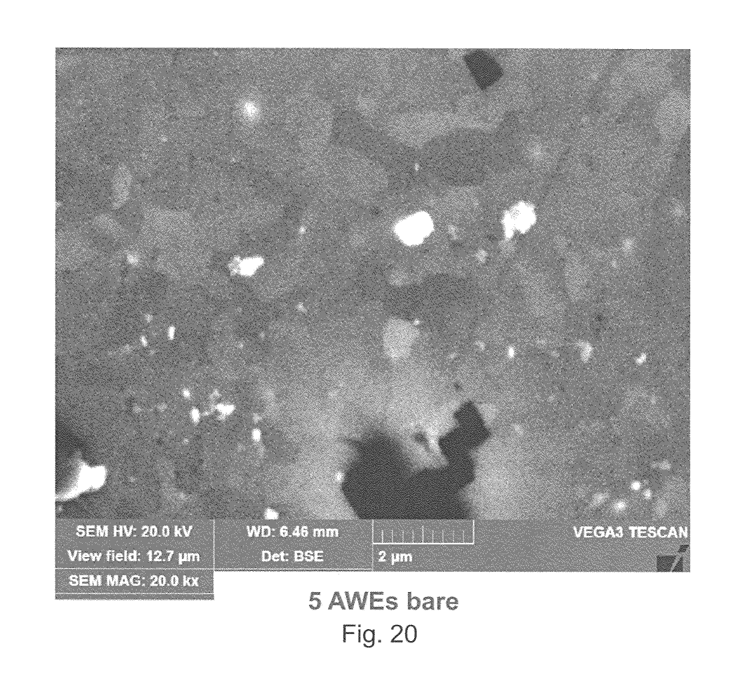

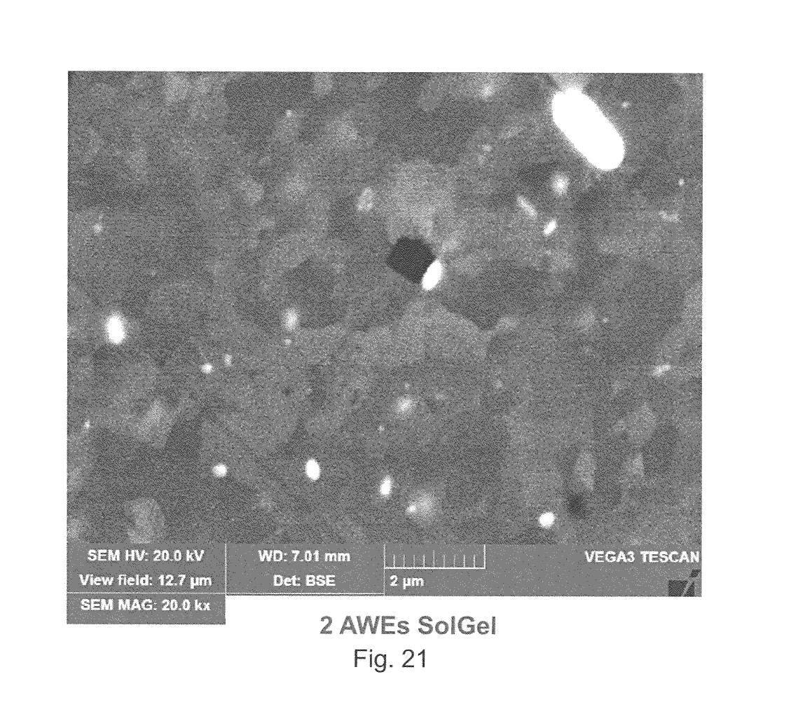

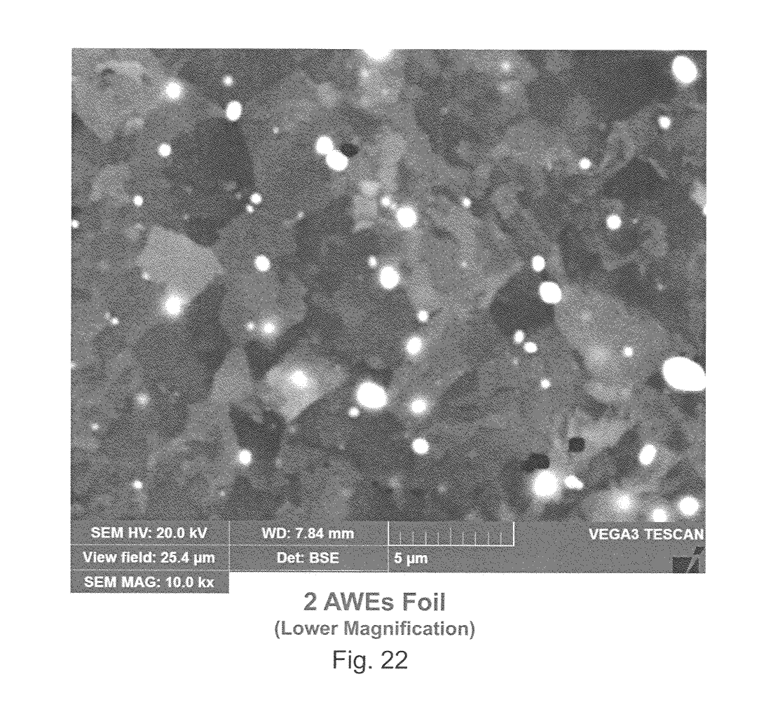

FIG. 20 provides a comparison of SEMs from three different runs, the 5 AWE bare AA1350, 2 AWE nanoparticle coated AA1350, and the 2 AWE foil, depicting the structure comparisons in the final wire product. In all three SEM images, significant substructure refinement is depicted.

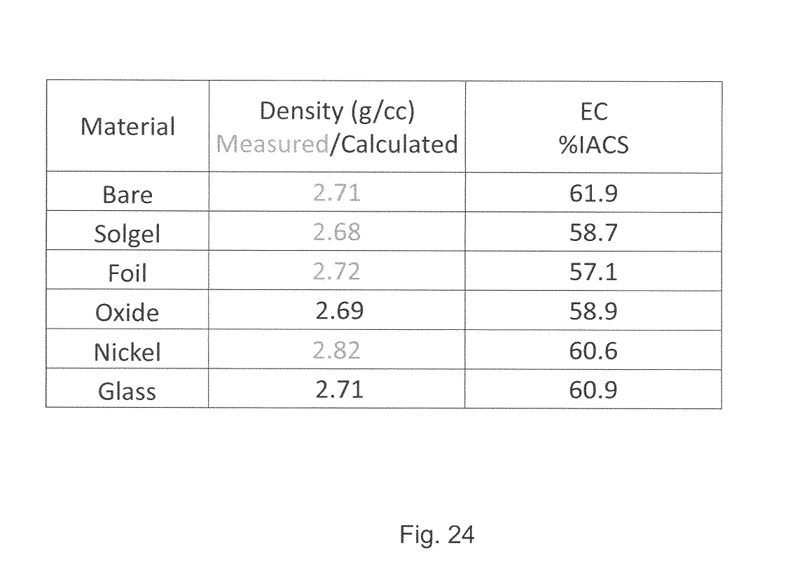

FIG. 24 provides a table comparing various wire product material and the final properties (i.e. density and electrical conductivity) measured in the wire product.

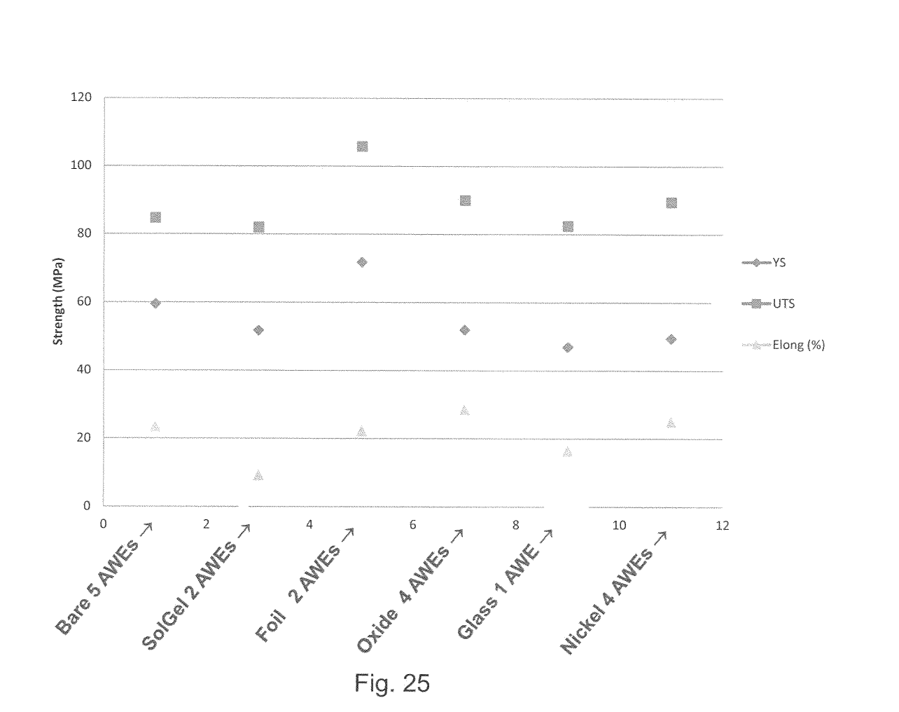

FIG. 25 is a graph depicting the preliminary mechanical properties (yield strength, ultimate tensile strength, and elongation) at room temperature for each of the tested materials.

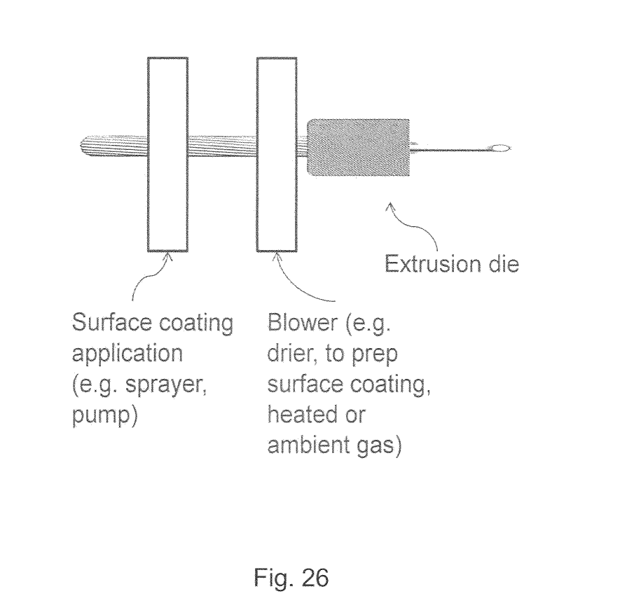

FIG. 26 depicts a schematic of an alternative embodiment of an extrusion device, wherein the extruder comprises a device for coating wires with a surface coating/surface treatment (e.g. sprayer, atomizer, pump) and a drier (e.g. a blower to dry/prepare the sprayed wire for extrusion, remove excess moisture, and/or retain the surface treatment/coating in place). In some embodiments, the drier comprises a gas which is blown onto the surface of the wires. In some embodiments, the drier comprises a heat and/or light application area to dry and/or cure the surface treatment).

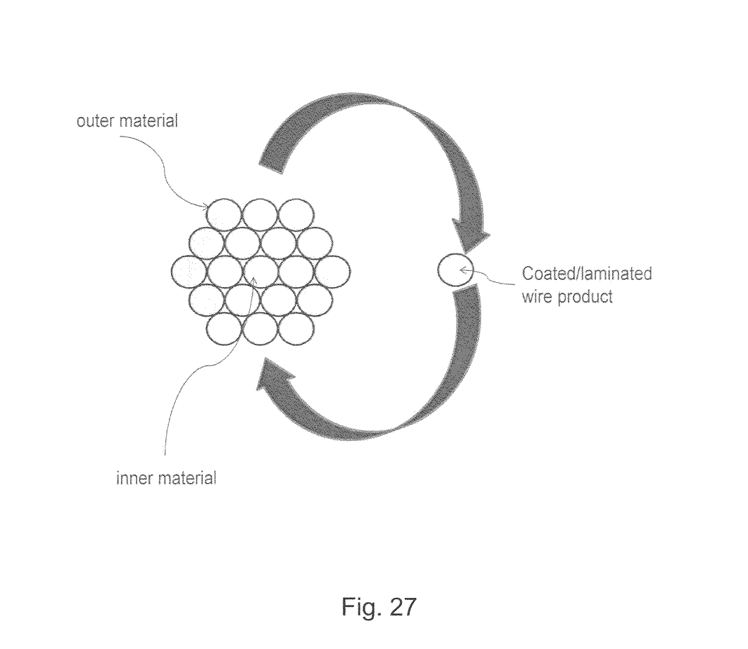

FIG. 27 provides a schematic of a laminated structure in accordance with the instant disclosure, in which the outer material comprises one physical property (e.g. high strength material) and the inner material comprises another physical property (e.g. high electrical conductivity).

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

What is claimed is:

1. A composite product, comprising:
an extrusion including a parent material and a non-parent material,
wherein the parent material comprises a metal material;
wherein the non-parent material comprises a particulate material embedded within the parent material and dispersed within the parent material, wherein the parent material is different from the non-parent material.

2. The product of claim 1, wherein the parent material is selected from the group consisting of: aluminum, aluminum alloy, magnesium, magnesium alloy, titanium, titanium alloy, copper, copper alloy, steel, steel alloy, iron, iron alloy, nickel, nickel alloy, and combinations thereof.

3. The product of claim 1, wherein the non-parent material comprises: a metal; a chemically oxidized parent material; a nanomaterial, a non-metallic material; and combinations thereof.

4. The product of claim 1, wherein the non-parent material in the composite material comprises: a metal material having an average particle size of not greater than about 1 micron.

5. The product of claim 1, wherein the non-parent material comprises a material having an average particle size of not greater than about 20 nanometers.

6. The product of claim 1, wherein the non-parent material is uniformly dispersed in the composite product.

7. A method, comprising:
(a) providing a plurality of members comprising a parent material and a non-parent material, wherein the parent material is different from the non-parent material; and
(b) extruding the plurality of members to form a composite product,
wherein, via the extruding step, the composite product comprises a plurality of particles of the non-parent material,
wherein the particles having an average particle size of not greater than about 5 microns,
wherein the particles of non-parent material are embedded within the parent material.

8. The method of claim 7, wherein providing comprises:
providing a group of individual members, including a plurality of members comprising a parent material and at least one member comprising a non-parent material, wherein the parent material is different from the non-parent material.

9. The method of claim 8, wherein the extruding step comprises: co-adding the parent members and non-parent members to the extruder.

10. The method of claim 7 wherein the providing step comprises:
surface treating at least some of a plurality of individual members of a parent material to create a coating on at least some of the members,
wherein the members comprise a parent material and the coating comprises a non-parent material, wherein the parent material is different from the non-parent material.

11. A method, comprising:
(a) surface treating at least some of a plurality of individual members of a parent material to create a coating on at least some of the members, wherein the members comprise a parent material and the coating comprises a non-parent material, wherein the parent material is different from the non-parent material, wherein the coating includes a thickness of not greater than about 30 microns;
(b) extruding the plurality members to form a composite product,
wherein, via the extruding step, the composite product comprises a plurality of particles of the non-parent material,
wherein the particles having an average particle size of not greater than about 1 micron,
wherein the particles of non-parent material are embedded within the parent material.

12. The method of claim 11, wherein the surface treating step comprises surface treating all members.

13. The method of claim 11, the method further comprises:
(c) cutting the composite product into a plurality of composite product sections; and
(d) repeating steps (a) and (b) to provide a composite product having an increased amount of non-parent material embedded within the parent material when compared to the composite product formed from a single pass of step (a) and (b).

14. The method of claim 11, the method further comprises:
(c) cutting the composite product into a plurality of composite product sections; and
(d) performing a second extruding step to create a second composite product having at least one of: (i) an increased amount of dispersion between the particles and (ii) a reduced average particle size as compared to the composite product formed in step b.

15. The method of claim 11, wherein surface treating is selected from the group consisting of: painting, electroplating, covering; anodizing, chemically reacting, depositing via chemical vapor deposition, and combinations thereof.
